(19) United States
(12) Patent Application Publication
(10) Pub. No.: US 2024/0175535 A1
(43) Pub. Date: May 30, 2024

(54) SYSTEMS AND METHODS FOR REMOTE INSPECTION, MAPPING AND ANALYSIS

(71) Applicant: SUBTERRA AI INC., Cincinnati, OH (US)

(72) Inventor: Robert Chester Lee, Cincinnati, OH (US)

(21) Appl. No.: 18/551,118

(22) PCT Filed: Mar. 21, 2022
(86) PCT No.: PCT/US2022/021175

§ 371 Date: Sep. 18, 2023

Related U.S. Application Data
(60) Provisional application No. 63/163,459, filed on Mar. 19, 2021.

(51) Int. Cl. F16L 55/48; F16L 101/30; G03B 37/00

(52) U.S. Cl. CPC F16L 55/48; G03B 37/005; F16L 2101/30

(57) ABSTRACT

The disclosure relates to a system for mapping a confined space. The system includes a mapping device comprising a camera configured to capture image data depicting a transit of the confined space by the mapping device. The system includes an image processing system comprising a processor and a memory, wherein the processor is configured to execute instructions stored on the memory to perform the operations of processing the image data to determine a first set of locations of the mapping device as it transits the confined space; and processing the image data to determine a second set of locations of one or more features or one or more defects associated with the confined space.

### CROSS-REFERENCE TO RELATED APPLICATION(S)

This application claims the benefit of and priority to U.S. Provisional Application No. 63/163,459, filed on Mar. 19, 2021, entitled “SYSTEMS AND METHODS FOR REMOTE INSPECTION, MAPPING AND ANALYSIS,” which is hereby incorporated by reference in its entirety.

### TECHNICAL FIELD

The present systems and methods are directed to remote inspection, mapping technology, data storage, data process, data analysis, web viewing and, in some embodiments, to remote inspection and mapping of a subterranean system.

### BACKGROUND

Inspecting the condition of confined spaces, such as pipes, manholes and specifically collection systems, is a difficult and dangerous task. Inspection may be done manually or using tethered CCTV rovers and floats controlled from the surface using a cable. These inspection methods and data analysis are often slow, expensive, or dangerous. There is a need for a safe, cost-effective, efficient, objective, and accurate solution to inspect and map these subterranean infrastructures. In addition, there is a need to use software tools to extract and analyze data from existing solutions.

### SUMMARY

In one aspect, the subject matter of this disclosure relates to a system for mapping a confined space. The system may include a mapping device including a camera configured to capture image data depicting a transit of the confined space by the mapping device. The system may include an image processing system including a processor and a memory, wherein the processor is configured to execute instructions stored on the memory to perform the operations of processing the image data to determine a first set of locations of the mapping device as it transits the confined space; and processing the image data to determine a second set of locations of one or more features or one or more defects associated with the confined space. The camera may be disposed on a camera module removably attached to the mapping device. The system may include a light module removably attached to the mapping device, the light module including an array of lights disposed about the mapping device. The system may include a float attachment structure, wherein the mapping device is removably disposed on or in the float attachment structure. The float attachment structure may define a channel extending at least in part through the float attachment structure. The float attachment structure may include at least one fin and/or at least one hull. The at least one fin may include an attachment hole configured to connectably receive a tether or a drag chain. The at least one hull may include a bore extending through the at least one hull, wherein the bore is configured to cool and stabilize the mapping device. The system may include a roll bar attached to the mapping device. The mapping device may include one or more sensors, the one or more sensors including a luminance sensor, a barometer, a gas sensor, a humidity sensor, a temperature sensor, a tactile sensor, a proximity sensor, a sonar sensor, or a LIDAR sensor. At least a portion of the system may be modular and physically configurable based on one or more environments in which the portion of the system is disposed, the one or more environments including a vertical confined space, a pipe, a subterranean environment, a vehicle, or a storage container. The processing the image data to determine the first set of locations of the mapping device may include providing the image data as input to a visual simultaneous localization and mapping algorithm; and mapping an environment within the confined space as a sparse point cloud. The operations may further include transforming the sparse point cloud to fit into a real-world location. The operations may further include mapping the first set of locations of the mapping device and the second set of locations of the one or more features or one or more defects to respective geographic coordinates. The one or more features may include a manhole, a start of a pipe, a sewer segment, or a lateral connection. The one or more defects may include a rock, debris, or a surface defect of the confined space. The operations may further include stabilizing the image data. The operations may further include tagging the image data with one or more identifiers, the identifiers including a sound signature or a scannable code. The image processing system may be located in a server different than the mapping device.

These and other objects, along with advantages and features of embodiments of the present invention herein disclosed, will become more apparent through reference to the following description, the figures, and the claims. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which.

FIG. 1a depicts a schematic view of an mapping device, according to an embodiment of the present disclosure;

FIG. 1b depicts a cross-sectional view of the mapping device, according to an embodiment of the present disclosure;

FIG. 1c depicts a schematic view of a camera module with a base, according to an embodiment of the present disclosure;

FIG. 2a depicts a side view of a float attachment structure, according to an embodiment of the present disclosure;

FIG. 2b depicts a cross-sectional view of the float attachment structure, according to an embodiment of the present disclosure;

FIG. 2c depicts a schematic view of the float attachment structure, according to an embodiment of the present disclosure;

FIG. 2d depicts a mapping device disposed in the float attachment structure, according to an embodiment of the present disclosure;

FIG. 3a depicts a schematic view before the mapping device is inserted into the float attachment structure, according to an embodiment of the present disclosure;

FIG. 3b depicts a schematic view after the mapping device is inserted into the float attachment structure, according to an embodiment of the present disclosure;

FIG. 3c depicts a schematic view of adding a hull onto the mapping device with the float attachment structure, according to an embodiment of the present disclosure;

FIG. 3d depicts a schematic view of a tether and a drag chain connected to the mapping device with the float attachment structure, according to an embodiment of the present disclosure:

FIGS. 4a-d show a modularity of the mapping device which allows the mapping device to be adapted based on an intended application, according to an embodiment of the present disclosure;

FIGS. 5a and 5b schematically depict a deployment system, according to an embodiment of the present disclosure;

FIGS. 6a and 6b schematically depict a deployment system, according to an embodiment of the present disclosure;

FIG. 7 schematically depicts a deployment system, according to an embodiment of the present disclosure;

FIG. 8 is a flow chart depicting a method of using an mapping device, according to an embodiment of the present disclosure;

FIG. 9 schematically depicts a deployment and retrieval of an mapping device, according to an embodiment of the present disclosure;

FIG. 10 depicts pairing of a camera and a form created on a secondary device like a smartphone or tablet, according to an embodiment of the present disclosure:

FIG. 11 is a flow chart depicting a method of analyzing data from the mapping device, according to an embodiment of the present disclosure;

FIG. 12 depicts the segmentation of an inspection based on reference points from within a confined space, according to an embodiment of the present disclosure:

FIG. 13 is a screenshot of data from an mapping device being analyzed, according to an embodiment of the present disclosure:

FIG. 14 is a screenshot of data from an mapping device being analyzed, according to an embodiment of the present disclosure:

FIG. 15 is a screenshot of data from an mapping device being analyzed, according to an embodiment of the present disclosure:

FIG. 16 depicts an equirectangular panoramic image of the sewer environment taken from the mapping device, according to an embodiment of the present disclosure:

FIG. 17 illustrates a transformation from an equirectangular panoramic image to a sphere and vice-versa, according to an embodiment of the present disclosure:

FIG. 18 illustrates an inspection of a pipe and the orientation of a clock reference, according to an embodiment of the present disclosure;

FIG. 19 is a screenshot depicting a 360° clock overlaid on top of a 360° image, according to an embodiment of the present disclosure:

FIG. 20 is a screenshot showing the detection of the water level observation within a pipe from a 360° image with a 360° clock to extract measurement, according to an embodiment of the present disclosure:

FIG. 21 depicts the calculation in determining the height of water within a pipe using the segment algorithm of a circle, according to an embodiment of the present disclosure,

FIG. 22 is an image of a typical CCTV sewer inspection looking straight down the pipe in the direction of the inspection, according to an embodiment of the present disclosure:

FIG. 23 is a clock overlay that is used for CCTV sewer inspection videos, according to an embodiment of the present disclosure:

FIG. 24 depicts an automatic detection of the waterline from CCTV sewer inspection and a calculation of the water height using the algorithm to measure a segment of a circle, according to an embodiment of the present disclosure;

FIG. 25 illustrates the calculation of a segment of a circle, according to an embodiment of the present disclosure;

FIG. 26 is a series of images of a RAW sewer video depicting water surface characterization for calculating the underlying base surface, according to an embodiment of the present disclosure:

FIG. 27 is a flowchart of water surface analysis, according to an embodiment of the present disclosure; and

FIG. 28 illustrates how underlying surface impacts water surface characteristic, according to an embodiment of the present disclosure.

### DETAILED DESCRIPTION

Various non-limiting embodiments of the present disclosure will now be described to provide an overall understanding of the principles of the structure, function, and use of the apparatuses, systems, methods, and processes disclosed herein. One or more examples of these non-limiting embodiments are illustrated in the accompanying drawings. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment,” or “in an embodiment” in places throughout the specification are not necessarily all referring to the same embodiment. Furthermore, the particular features, structures or characteristics may be combined in any suitable manner in one or more embodiments.

Described herein are example embodiments of apparatuses, systems, and methods for remote inspection and mapping. The example embodiments described herein can provide remote inspection or mapping of a system, such as a subterranean system. In some embodiments where the system to be inspected includes liquid (e.g., a sewer system), the remote device can be configured to float through the system. In various embodiments, the system may be dry, partially filled with liquid or other material, or fully filled with liquid or other material. Remote inspection or mapping provided by example embodiments described herein reduces or eliminates the danger of manual inspection and can be easier to use, more cost-effective, and more accurate than existing inspection technology.

The examples discussed herein are examples only and are provided to assist in the explanation of the apparatuses, devices, systems and methods described herein. None of the features or components shown in the drawings or discussed below should be taken as mandatory for any specific implementation of any of these apparatuses, devices, systems or methods unless specifically designated as mandatory. For ease of reading and clarity, certain components, modules, or methods may be described solely in connection with a specific figure. Any failure to specifically describe a combination or sub-combination of components should not be understood as an indication that any combination or sub-combination is not possible. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel. Any dimension or example part called out in the figures are examples only, and the example embodiments described herein are not so limited.

It is contemplated that apparatus, systems, methods, and processes of the claimed invention encompass variations and adaptations developed using information from the embodiments described herein. Adaptation and/or modification of the apparatus, systems, methods, and processes described herein may be performed by those of ordinary skill in the relevant art.

It should be understood that the order of steps or order for performing certain actions is immaterial so long as the invention remains operable. Moreover, two or more steps or actions may be conducted simultaneously.

With reference to the drawings, the invention will now be described in more detail. The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). Reference throughout this document to “one embodiment”, “certain embodiments”, “an embodiment”, “an implementation”, “an example” or similar terms means that a particular feature, structure, or characteristic described in connection with the embodiment is included in at least one embodiment of the present disclosure. Thus, the appearances of such phrases or in various places throughout this specification are not necessarily all referring to the same embodiment. Furthermore, the particular features, structures, or characteristics may be combined in any suitable manner in one or more embodiments without limitation.

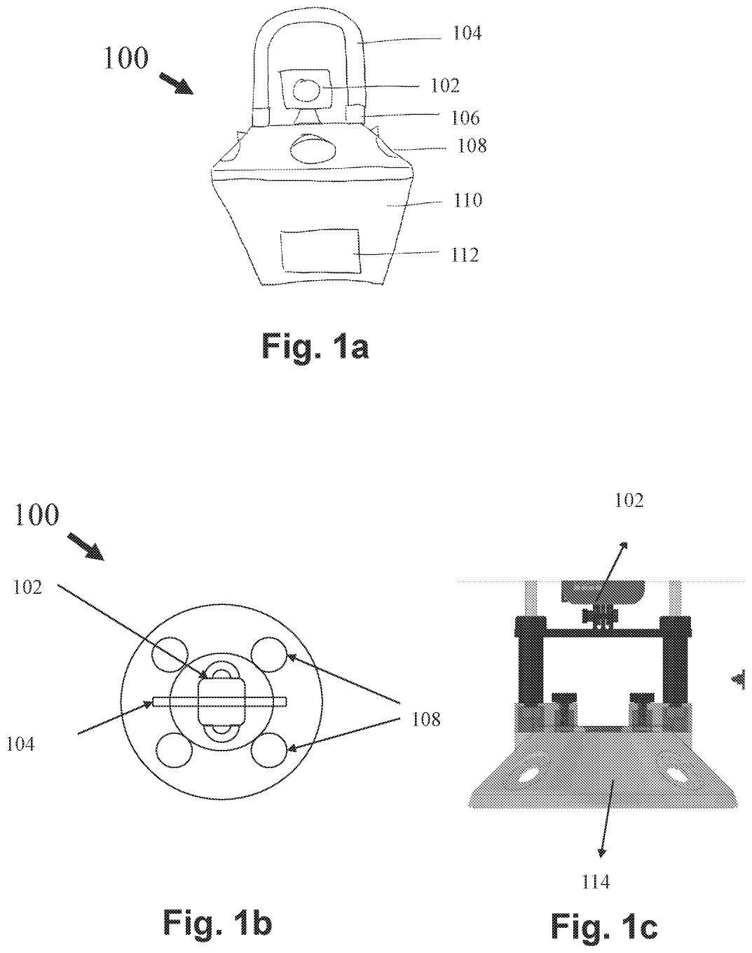

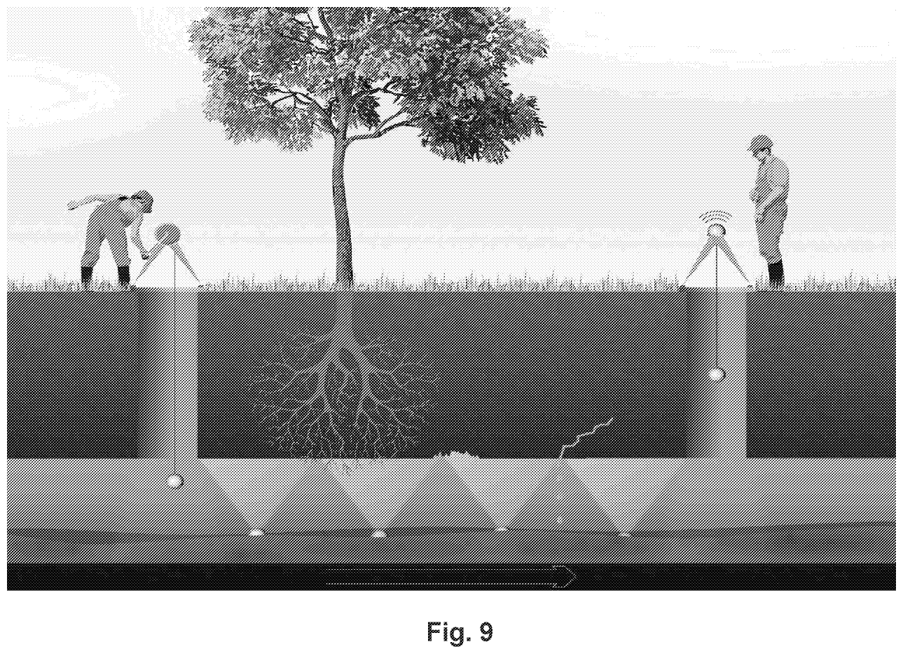

Referring to FIGS. 1-4 discussed below, in one embodiment, a mapping device 100 can be an inspection device to perform a remote inspection, and the inspection device can be modular. In one embodiment, the mapping device 100 can include a camera module 102, one or more light modules, a power module, and a platform module. In some embodiments, the camera module may be used alone. The camera module 102 can be located in a center portion of the mapping device 100. The one or more lighting modules can surround the camera module 102. In some embodiments, a platform module can act as a platform for various sensors or electrical components, as discussed further below. The platform module may be a float, in various embodiments, allowing the inspection device to float through the system being inspected. The mapping device 100 can be untethered or tethered and equipped with sensors to capture both the environment and the state of the device as it floats through the system being inspected. The mapping device 100 can be lowered into a confined space, e.g., from a standard maintenance access chamber or hole, and remotely released into the sewer as shown later in FIG. 9. The mapping device 100 can then use the flow of the water to transport it through the system. The mapping device 100 can capture several data sets including, without limitation, ultra-high definition (UHD) and high definition (HD) videos, high resolution images, inertial measurement unit (IMU) data such as pose of the mapping device 100, trajectory, and environmental data. The data can be processed, e.g., stabilized, and analyzed to reconstruct in three dimensions. The data shows the environment through which the mapping device 100 travels. The data can also be used in geolocating the mapping device 100, geolocating features within the pipe, comparing changes over time, measuring dimensions, measurement of environmental features and performing condition assessments of the system.

FIG. 1a depicts a schematic view of an mapping device 100, according to an embodiment of the present disclosure. FIG. 1b depicts a cross-sectional view of the mapping device 100, according to an embodiment of the present disclosure. FIG. 1c depicts a schematic view of a camera module with a base, according to an embodiment of the present disclosure.

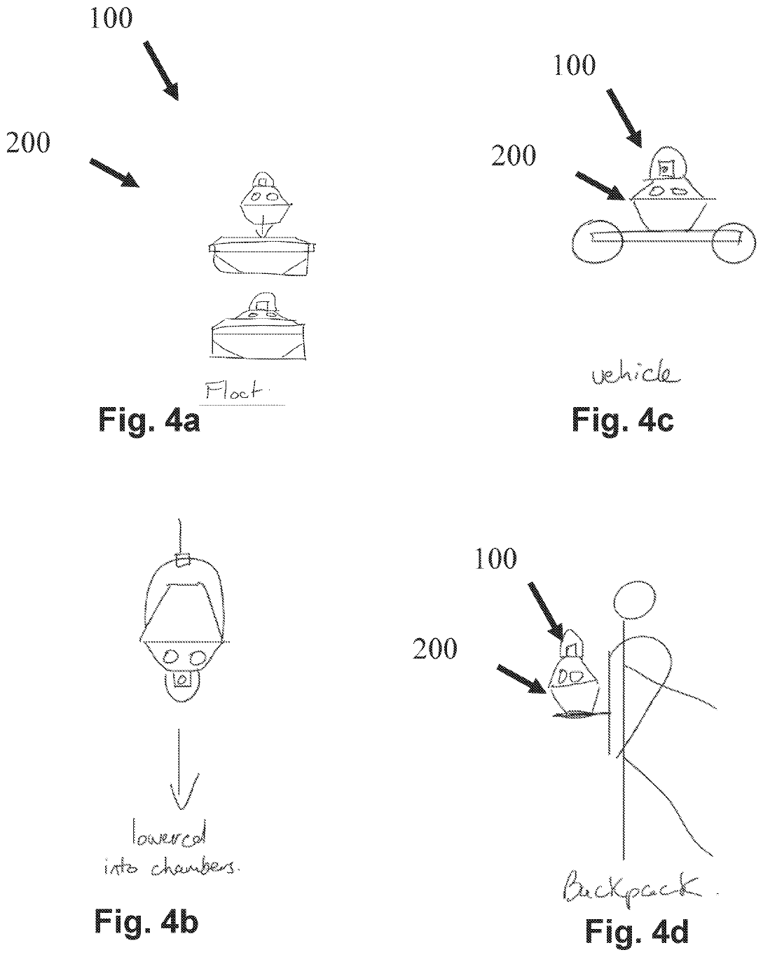

In one embodiment, the mapping device 100 in FIG. 1a can be an inspection device, and the mapping device can also be a remote device. In some embodiments, the mapping device 100 can be a modular mapping device. The mapping device 100 can include a camera module 102, a light detection and ranging device (LIDAR), or sensors. The camera module 102 can include one or more cameras. The one or more cameras can be pinhole cameras or 360° cameras. In some embodiments, the camera module 102 can also include an array of cameras that provide a 3600 view. The camera module 102 can also include an internal power source (not shown) operably configured to power the one or more cameras. The camera module 102 can include a camera housing, such as a domed housing or waterproof housing, coupled to a base 114 as shown in FIG. 1c. In some embodiments, the camera module 102 can be waterproof. In some embodiments, the camera module can be modular and can be reconfigured based on applications such as environments of the mapping device 100, which is shown later in FIGS. 4a-4d.

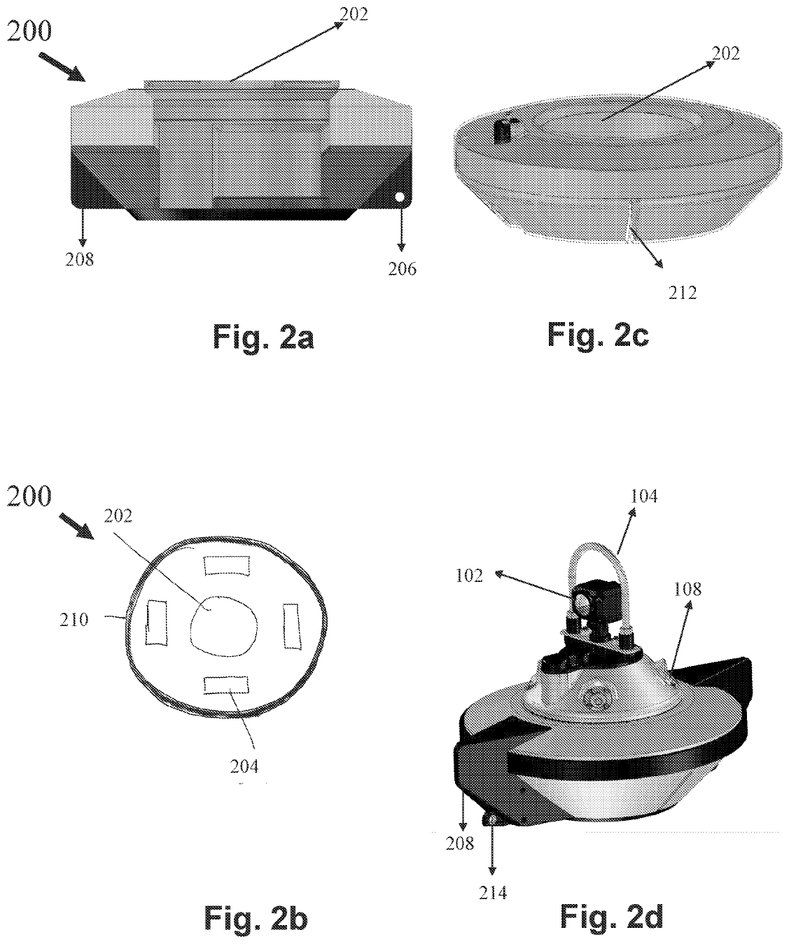

In one embodiment, the mapping device 100 includes a roll bar 104. The roll bar 104 can be used to provide a protection of the mapping device 100 during the inspection. The roll bar 104 can be connected to the mapping device 100 via adjustment attachment 106. The adjustment attachment 106 can be a pillar, a bar, or the like. The roll bar 104 can be adjacent to the camera module 102. The adjustment attachment 106 can be rotated so an angle between the roll bar 104 and a top surface of the mapping device 100 can be adjusted. The roll bar 104 can indicate how the mapping device 100 and the float attachment structure 200 (see shown in FIG. 2a) is lowered and released. In some embodiments, the roll bar 104 can be detached from the mapping device 100.

In one embodiment, the mapping device 100 can include a light module, and the light module can include an array of lights such as a LED array 108, which can be rotated by 360°. The LED array 108 can illuminate a confined space with enough light to capture a clear image or video. By creating the LED array 108, which can be a spaced-out array, the light covers the area for the 360° images to be captured. In some embodiments, the light module can be modular, and the light module can be reconfigured based on applications such as environments of the mapping device 100.

In one embodiment, the mapping device 100 can include a power module including a battery 112 located on the bottom of the mapping device 100, and the battery can be lithium polymer battery, or the like. The battery 112 can be covered by a modular battery case 110, which is located around the battery 112 and under the LED array 108. The battery case 110 can be used to protect the battery 112 in the mapping device 100. In some embodiments, the power module can be modular, and the power module can be reconfigured based on such as environments of the mapping device 100.

FIG. 2a depicts a side view of a float attachment structure 200, according to an embodiment of the present disclosure. FIG. 2b depicts a cross-sectional view of the float attachment structure 200, according to an embodiment of the present disclosure. FIG. 2c depicts a schematic view of the float attachment structure 200, according to an embodiment of the present disclosure. FIG. 2d depicts a mapping device disposed in the float attachment structure 200, according to an embodiment of the present disclosure.

In an embodiment, the float attachment structure 200 can be a float platform. The float attachment structure 200 can be a platform module. The float attachment structure 200 can include a well 202, which can be used to attach the float attachment structure 200 to the mapping device 100 as shown above in FIG. 1a. The float attachment structure 200 allows the mapping device 100 to be released into a flowing pipe like a sewer. The float attachment structure 200 protects and keeps afloat the power module, the light module, and the camera module 102. The float attachment structure 200 can be circular and can have fins 208. The well 202 can be a circle, a rectangle, or any shape that can fit the shape of the mapping device 100. The well 202 can be located in the middle of the float attachment structure 200 surrounded by an array of sensor wells 204. The array of sensor wells 204 are space for supplementary sensors such as sound or sonde locating devices, gas monitors, temperature sensors, humidity sensors, or light. The shape of the array of sensor wells 204 can be rounded. The array of sensor wells 204 allows the system to put different payloads on the float attachment structure 200 along with the mapping device 100.

In one embodiment, the float attachment structure 200 can have attachment holes 206, which are located around the outer surface of the float attachment structure 200. The attachment holes 206 can connect to a hull 302 or a drag chain 308. The attachment holes 206 allow for bolting on or attaching secondary structures, e.g., the hull 302 or the drag chain 308, to the fins 208. The drag chain 308 can be added for more weights, or bigger stabilizers like a yacht shape hull can also be added. The attachment holes 206 can be disposed on the fins 208. The fins 208 can slow down or remove the spinning of the float attachment structure 200 in a fluid like water or sewage. The float attachment structure 200 inherently has the characteristic of spinning in water. The fins 208 can create drag and cause the float not to spin. A bumper 210 can be placed around the outer surface of the float attachment structure 200 and the bumper 210 can be used to protect the float attachment structure 200. The bumper 210 can be disposed in a periphery of the float attachment structure 200.

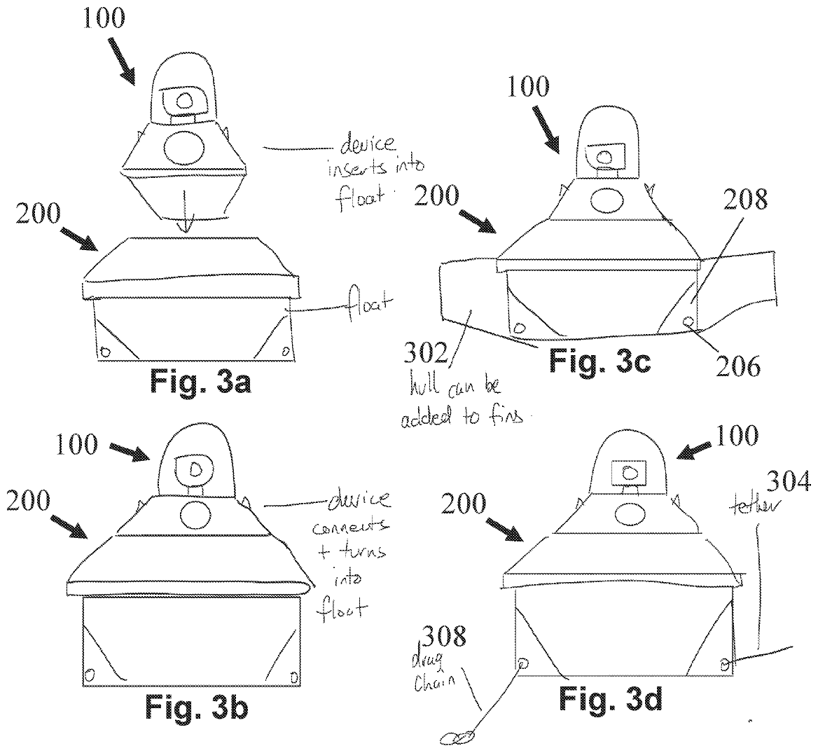

FIG. 3a depicts a schematic view before the mapping device 100 is inserted into the float attachment structure 200, according to an embodiment of the present disclosure. FIG. 3b depicts a schematic view after the mapping device 100 is inserted into the float attachment structure 200, according to an embodiment of the present disclosure.

In one embodiment, the mapping device 100 is inserted from the top of the float attachment structure 200 into the float attachment structure 200 as shown in FIG. 3a. The insertion of the mapping device 100 into the float attachment structure 200 allows for the mapping device 100 to be deployed into a semi filled gravity fed pipe or conduit as it floats on top of the fluid. In FIG. 3b, the mapping device 100 is inserted into the float attachment structure 200, and the width of the mapping device 100 is the same or substantially the same as the width of the float attachment structure 200.

FIG. 3c depicts a schematic view of adding a hull 302 onto the mapping device 100 with the float attachment structure 200, according to an embodiment of the present disclosure. FIG. 3d depicts a schematic view of a tether 304 and a drag chain 308 connected to the mapping device 100 with the float attachment structure 200, according to an embodiment of the present disclosure.

In one embodiment, hulls 302 can be added to the fins 208 of the float attachment structure 200. The hulls 302 can be on both sides of the fins 208 and can be adjacent to the fins 208 and attachment holes 206. The attachment holes 206 can be disposed on the fins 208. One or more drag chains 308 connect to the float attachment structure 200 by the attachment holes 206. The purpose of adding the hulls 302 to both sides of the fins is to give the float attachment structure 200 more fluid dynamic characteristics. The hulls 302 aid in stabilizing the float attachment structure 200 in rougher, higher velocity and/or turbulent flows.

In one embodiment, a modularity of the mapping device 100 is used in FIGS. 3a-3d. The mapping device 100 can be inserted and attached to the float attachment structure 200. The float attachment structure 200 has attachment ports allowing for other attachments to be connected to the float attachment structure 200. These include, but are not limited to, fins 208, and drag chain 308 or weights to slow the mapping device 100 in a fast flow.

In an embodiment, cameras modules 102 can be coupled to a base 114 shown in FIG. 1c via an attachment, which can be a GO-pro styled pronged attachment that is on the base 114 shown in FIG. 1c. In some embodiments, shape of the camera housing for the cameras can be any shape that fits the cameras. The attachment and the base can also have any shapes. For example, the base 114 can be, without limitation, circular, oval, diagonal, rectangular, polygonal, torpedo-shaped, etc.

FIGS. 4a-d show a modularity of the mapping device 100 which allows the mapping device to be adapted based on an intended application, according to an embodiment of the present disclosure. The mapping device 100 can be used on the float attachment structure 200 as shown in FIG. 4a. The mapping device 100 can be lowered into chambers as shown in FIG. 4b. The mapping device 100 can also be taken out of the float attachment structure 200, turned upside down, and connected to a line (e.g., rope, wire line, steel wire, etc.) and lowered through an access port like a manhole into a confined space like a manhole chamber. The mapping device 100 can be further used in different environments, such as through maintenance shafts, pipes, or subterranean environments. In some embodiments, the maintenance shafts can be manholes and other vertical confined spaces The mapping device 100 can also be attached to a non-floating platform such as, for example, a vehicle in FIG. 4c or a person using a backpack as shown in FIG. 4d. In some embodiments, the inspection system including the mapping device 100 and the float attachment structure 200 can be attached to several transport mediums by modular attachments. The modular attachments can be rounded wells. The modular attachments can be located in a center portion of the float attachment structure 200. The inspection system can be attached to a wire and lowered down vertical shafts. The inspection system can be a sled to be pulled or pushed, a vehicle, a rover, a backpack, or the like.

In an embodiment, the mapping device 100 discussed above in FIGS. 1-4 can be a remote device. The mapping device 100 can also be a modular device. The mapping device 100 can include one or more sensors or electronic components. For example, the one or more sensors include, but not limited to, a luminance sensor, a barometer, a gas sensor, a humidity sensor, a temperature sensor, a tactile sensor, a proximity sensor, a sonar sensor, a LIDAR sensor, or a combination thereof. In some embodiments, the LIDAR sensor can replace the camera module 102 or the; light module.

In an embodiment, in addition to a camera module 102, the mapping device 100 can include an imaging system, and the imaging system can include, for example, a multispectral imaging sensor, a thermal imaging sensor, or a combination thereof. In some embodiments, image processing system of the imaging system may be located in a server different than the mapping device.

In an embodiment, the mapping device 100 includes a lumen output. The lumen output can be controlled by a luminance sensor based on a size of the surroundings of the mapping device 100, e.g., a size of a pipe that the mapping device 100 is inspecting.

In an embodiment, the mapping device 100 can include an inertial measurement unit (IMU) or a gyro sensor, and an inertial measurement measured by the inertial measurement unit can be used for surface water characterization analysis. The mapping device 100 can include a calibration board or card to perform processing or post processing, such as color correcting raw video from the camera. The mapping device 100 can include an audio/acoustic component to provide an acoustic signal (e.g., chirp) to, for example, assist in locating the mapping device 100 and to sense a structural integrity of pipe condition. In some embodiments, the acoustic signal can include data being transmitted over sound.

In an embodiment, the mapping device 100 can include a transmission component to wirelessly send data such as a velocity of the mapping device 100. In some embodiments, the sensors or electronic components may be coupled to a platform module, and the platform module can be the float attachment structure 200.

Referring to FIGS. 1-4, in various embodiments, the mapping device 100 can be a remote device, and the remote device can include a light module. The light module can include one or more lights such as the LED array 108. The one or more lights can be positioned in a lighting capsule. The one or more lights can include, but are not limited to, high lumen LEDs. In an embodiment, the lights can be equally spaced apart or can provide a 3600 array such as the LED array 108 shown in FIG. 1a. Although the LED array 108 shown in FIG. 1a includes only four lights, but the number of lights may vary. In some embodiments, one or more of the lights in the LED array 108 can be selectively coupled to the light base, where the LED array 108 is connected. For example, the lights can be coupled to the base 114 via fasteners such as screws, or the like. In some embodiments, the lights can be positioned at an angle relative to a top or bottom of the lighting base, which can reduce or eliminate lens flare. For example, the angle may be in a range of greater than 0° to 90°, 15° to 75°, 30° to 60°, 40° to 50°, 45°to 90°, 45° to 75°, 45° to 60°, or 60° to 90°. In an embodiment, the lights can be positioned at a 45° angle relative to the top or bottom of the lighting base. The angle of the lights may vary relative to each other.

Referring to FIGS. 1-3, in some embodiments, the mapping device 100 can be a remote device, and the remote device can include a power module. The power module can include a power source, such as one or more batteries, and a power housing. The power housing can be the battery housing 110 as shown in FIG. 1a. The power source can be operably coupled to the camera 102, the lights, or other electrical components of the remote device. The battery can be replaceable and or rechargeable. In an embodiment, the power housing can include a main body, and can also include one or more apertures that either attach to other sensors or components of the mapping device 100.

Referring to FIGS. 1-4, in some embodiments, the remote device can include a floatation platform module or platform. The lighting module including the LED array 108 and the power module including the batteries 112 are removably secured to the platform module. The platform module or the float attachment structure 200 can define a channel 212 extending partially or entirely through the platform module. In some embodiments, another module such as the power module, can be positioned in the channel. Such an arrangement can lower the center of gravity of the remote device. The camera module 102 can be removably secured to the platform module or one of the other modules. The platform can be configured to buoy the remote device when it is in a body of liquid, e.g., in a sewer system. The platform can be made of, for example, expanded polystyrene foam or roto-molded. Expanded polystyrene foam is used because it is durable and light. In some embodiments, the platform module can include a removable hull 302. The hull 302 as shown in FIG. 3c can improve the stability of the remote device when it is floating in moving liquid. The hull 302 can be unitary or made of more than one component. The hulls 302 can connect to the fins 208. In FIG. 3c, the hull 302 can contain first and second hull portions. Each of first and second hull portions can have a leading edge, attachment ports, and a connection to the float itself. The attachment ports 214 allow for a tether 304, as shown in FIGS. 2d and 3d, a drift chain, anchor, and sensors to be attached to the hull 302. The shape of the hull 302 can be designed to self-correct the position of the remote device. The hull 302 can include bores extending through the hull 302 to aid in cooling and stability of the remote device. The hull 302 can also include a heatsink to cool the remote device. The platform module can be generally circular, which reduces the possibility of the remote device getting stuck in a free-flowing body of liquid. The size and shape of the platform module can vary.

Referring to FIGS. 1-4, in some embodiments, the camera 102, light and power modules can be removably secured to one another. As shown in FIG. 1b, the camera module 102, light module, and power module can include mating features, such as a coupling/clamping ring, lip and a slot such that the camera module 102, light module, and power module can be interlinked. The camera module 102 and the light module can also be fastened together by fasteners to the light module with the power module. For example, the selective coupling can include, for example, a series of magnets coupling.

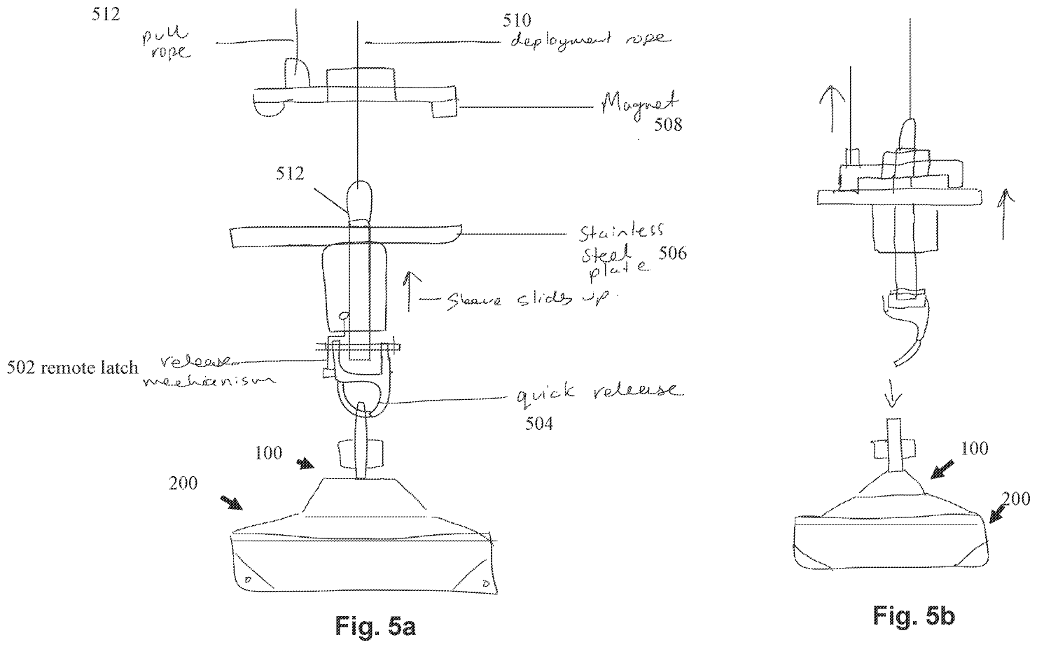

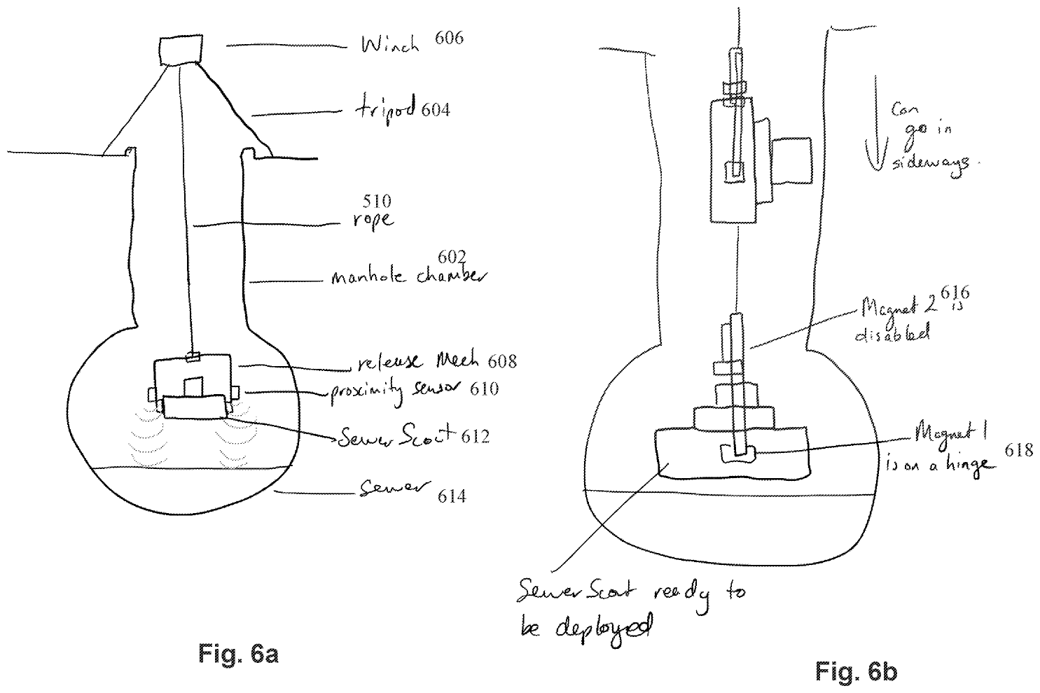

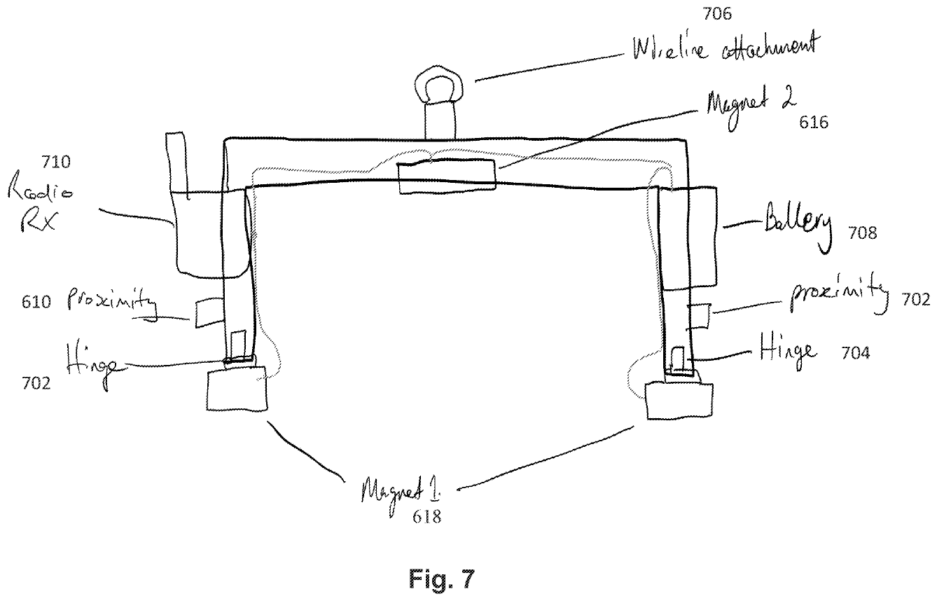

FIGS. 5a and 5b schematically depict a deployment system, according to an embodiment of the present disclosure. FIGS. 6a and 6b schematically depict a deployment system, according to an embodiment of the present disclosure. FIG. 7 schematically depicts a deployment system, according to an embodiment of the present disclosure. In some embodiments, the deployment system includes, but is not limited to, electromagnetic release mechanisms.

Referring to FIGS. 5a, 5b, and 6, the mapping device 100 can be deployed in a system or location to be inspected. In some embodiments, the mapping device 100, e.g., the remote devices or the modular device, can be untethered or tethered.

In an embodiment, the mapping device 100 can include a latch system as shown in FIGS. 5a and 5b for facilitating deployment of the mapping device 100. In some embodiments, as shown in FIGS. 5a, 5b, and FIG. 7, a latch in the latch system can be an electromagnetic latch or a mechanical latch. An example deployment system is shown in FIGS. 5a and 5b. The deployment system includes a stand, e.g., a tripod 604 in FIG. 6a. The stand can include a winch 606 positioned over the deployment location. In an embodiment, the deployment location is into a sewer pipe 614 from a manhole 602 or other access point. The winch 606 is coupled to the latch via, for example, a rope or a deployment rope 510. The mapping device 100 is releasably coupled to the latch. The latch can include a central rod 512 that connects the release latch mechanism 502 and the wireline attachment 706. The mapping device 100 is coupled between the mechanical latch arms. The central rod 512 has an outer rod with a magnet 508 and is connected to the release mechanism pin 504. When a secondary release rope and magnet 508 is lowered down, the release rope magnet 508 couples with a steel plate 506. The operator then pulls on the release rope 512 that pulls on the magnet 508 and respectively the steel plate 506 that is connected to the release pin 504. The release pin 504 is removed and the mechanical release latch opens and releases the mapping device 100. It will be appreciated that other latch configurations may be used.

In one embodiment, an example deployment system is shown in FIGS. 6a, 6b, and FIG. 9. The deployment system includes a stand, e.g., a tripod 604. The stand can include a winch 606 positioned over the deployment location. As described above, the deployment location is into a sewer pipe 614 from a manhole 602 or other access point. The winch 606 is coupled to a latch via, for example, a rope 510. The mapping device 100 is releasably coupled to the latch. The latch can include a crossbar and two arms extending therefrom. The mapping device is coupled between the arms. For example, the latch can include a first magnet 618 coupling the mapping device 100 to the arms. In an embodiment, the deployment system includes a proximity sensor 610 to determine how close the mapping device 100 is from the lower surface, e.g., from the water in the sewer pipe 614. The proximity sensor 610 may produce a signal notifying the user to stop lowering the mapping device 100. The first magnet 618 can be disabled to release the mapping device 100. In some embodiments, the deployment system can include a power source, a transmission system, e.g., multi-channel radio 710, etc. It is appreciated that other latch configurations may be used.

As shown in FIGS. 6a and 6b, in some embodiments, the mapping device 100 may be configured to move from a first secured position to a second secured position relative to the latch before being released. In the first secured position, the mapping device 100 may be positioned sideways, e.g., compared to its position after deployment, which can allow the mapping device 100 to be deployed through a smaller space than in the upright position.

In an embodiment, the latch can include a second magnet 616, which couples a side of the mapping device 100 to the crossbar in the first secured position. To move the mapping device 100 from the first secured position, e.g., sideways, to the second secured position, e.g., upright, the second magnet 616 is disabled, and the mapping device 100 rotates into the second secured position. In an embodiment, the mapping device 100 may be moved from the first secured position to the second secured position after the proximity sensor 610 signals that the mapping device 100 is at the desired height. FIGS. 6a and 6b show an example embodiment of a method of using an mapping device 100, e.g., the remote devices or the modular device. The deployment system can include a release mesh 608. The deployment system can include a sewer scout 612. The deployment system can include hinge 704 which is located by the first magnet 618. The deployment system also includes battery 708.

In an embodiment, the camera module 102 captures a full 360° view of the environment. The pan, tilt, and roll are recorded, e.g., by a gyro sensor, camera, etc. The camera module 102 can be used for mapping of the geolocation and the water surface characteristics analysis. As described above, the mapping device 100 can include a number of sensors for detecting, for example, the pressure, gas, humidity, or temperature. The mapping device 100 can be configured to record multispectral imaging or thermal imaging. In an embodiment where the mapping device 100 is floating, the camera module 102 captures the full exposed part of the pipe and the water surface. The mapping device 100 can float at the same speed or slower than the flowing liquid. The imaging system such as the camera module 102 and any other imaging components captures video and/or still images of the internal section of the pipe to be used in the geolocation and feature detection processing discussed further below. As shown in FIG. 9, a deployment and retrieval of an mapping device 100, according to an embodiment of the present disclosure.

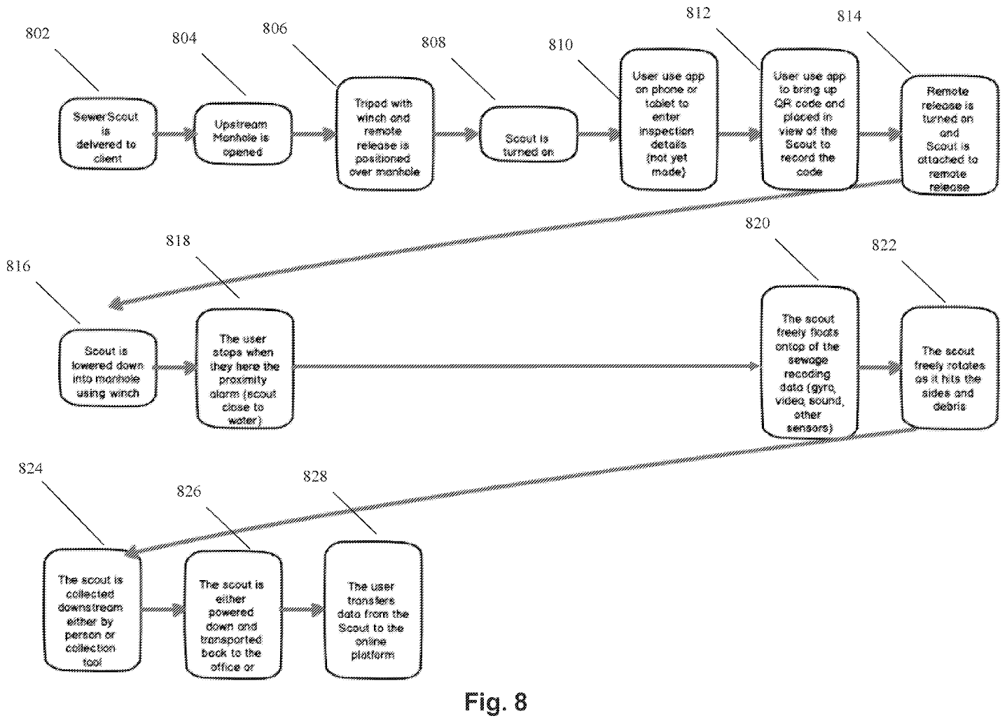

In an embodiment, data from the mapping device 100 is downloaded or transferred, uploaded to the cloud platform, processed, transformed and analyzed as shown in FIGS. 8, 10, 11, 12, 13, 14. The data, e.g., video, can be stabilized, e.g., to remove the influence of the spin or wobble of the mapping device 100. The data can be analyzed to detect defects in the surroundings and, with multiple uses, can compare change in the defect over time. The defects or other features of the surroundings may be identified manually, using a computer-implemented method, or using artificial intelligence.

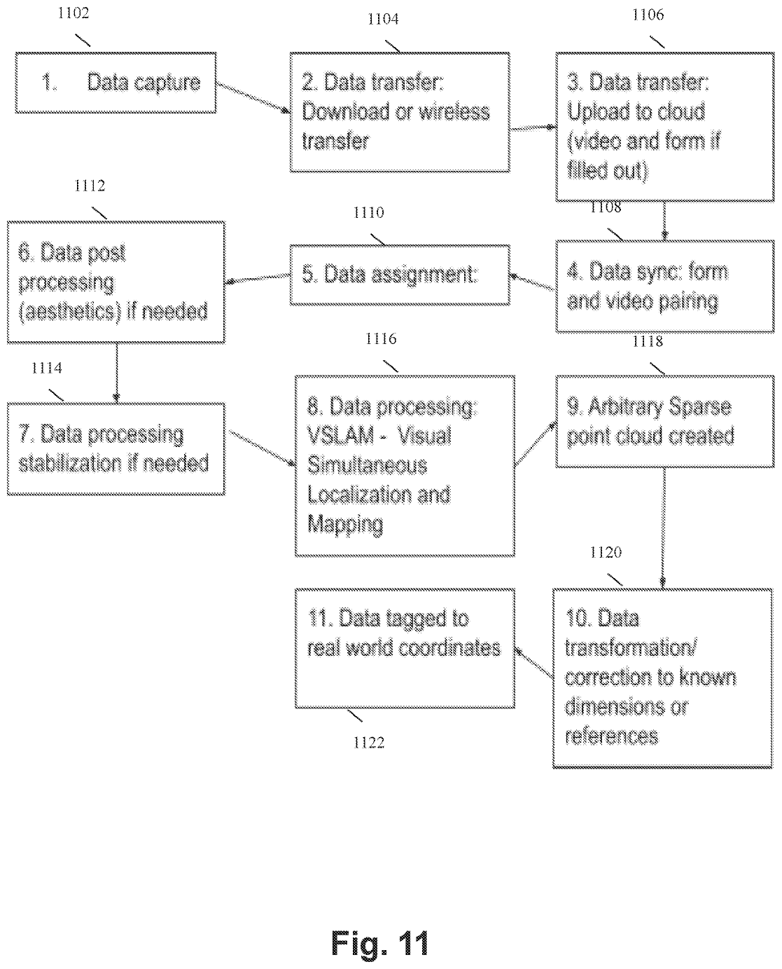

In an embodiment, an example workflow of the processing and analyzing is shown in FIG. 8 and 11. FIG. 8 is a flow chart depicting a method of using an mapping device 100, according to an embodiment of the present disclosure.

At step 802, an inspection system including the mapping device 100 and/or the float attachment structure 200 is delivered to a client.

At step 804, an upstream manhole is opened.

At step 806, a tripod with winch and remote release is positioned over the manhole.

At step 808, the inspection system is turned on.

At step 810, a user uses application on a phone or a tablet to enter inspection details.

At step 812, a user uses an application to bring up QR code and placed in view of the inspection system to record the code.

At step 814, a remote release is turned on and the inspection system is attached to the remote release.

At step 816, the inspection system is lowered down into the manhole using the winch.

At step 818, the user stops when the user is there with the proximity sensor, or the inspection system is close to water.

At step 820, the inspection system freely floats on top of the sewage recording data including gyro, video, sound, or other sensors.

At step 822, the inspection system freely rotates as it hits the sides and debris.

At step 824, the inspection system is collected downstream either by a person or a collection tool.

At step 826, the inspection system is either powered down or transported back to the office.

At step 828, the user transfers data from the inspection system to the online platform, or the user can upload a low resolution version of the video to a remote server, e.g., a cloud.

Referring to FIGS. 8, 10 and 11, data transfer such as download, transfer and upload are detailed. Data is downloaded from the camera module 102 or any other sensors as set out above. The data can be downloaded wirelessly, via a removable memory card, via a cord, etc. The operator logs into the secure internet cloud platform using a web browser that is connected to the internet. The operator can have login credentials that match their company account. The operator once logged in can drag and drop or browse files to add data from sensors and cameras. Data is uploaded to the cloud platform where it is securely stored and managed. The data is captured by the mapping device 100 and either stored on the mapping device 100 or wirelessly streamed from the mapping device 100 to a remote recording device. The data is uploaded to the secure cloud platform where it undergoes processing to geolocate it. The data can be paired with a prefilled form that the operator in the field fills out or the operator can assign the video to an asset via the platform at a later time. The prefilled form is the form that is on the smart device and filled out in the field. The forms can be attached to each video or image from the camera module 102. In some embodiments, the asset can be a physical piece of infrastructure like a manhole or sewer segment. The data can be processed to enhance the aesthetics (e.g. brightness, sharpness, exposure, etc.). The data can be stabilized using a stabilization algorithm to make the next step smoother. The video can be stabilized by removing the spin, wobble, jitter using computer vision and smoothing algorithms. The data is then put through the visual simultaneous localization and mapping (VSLAM) algorithm to detect and track features to localize the camera module 102 and then map the environment as a sparse point cloud with the location of the camera module 102 found. The point cloud is arbitrary, includes drift errors and needs further processing to get real world coordinates and correct scale without drift errors. Using the point cloud editor and image data, known real world references are identified within the data sets and given real world coordinates or measurements. The real world references are identifiable structures or assets, e.g. manhole chambers, a start of a pipe, lateral connections, or anything that has an identifiable characteristic that has its own asset ID. The point cloud goes through a bundle adjustment to transform the point cloud into an accurate real world representation. One method to remove drift errors from the VSLAM process is to run the process in reverse, compare the two point clouds and adjust for the incremental error that can be observed between the two.

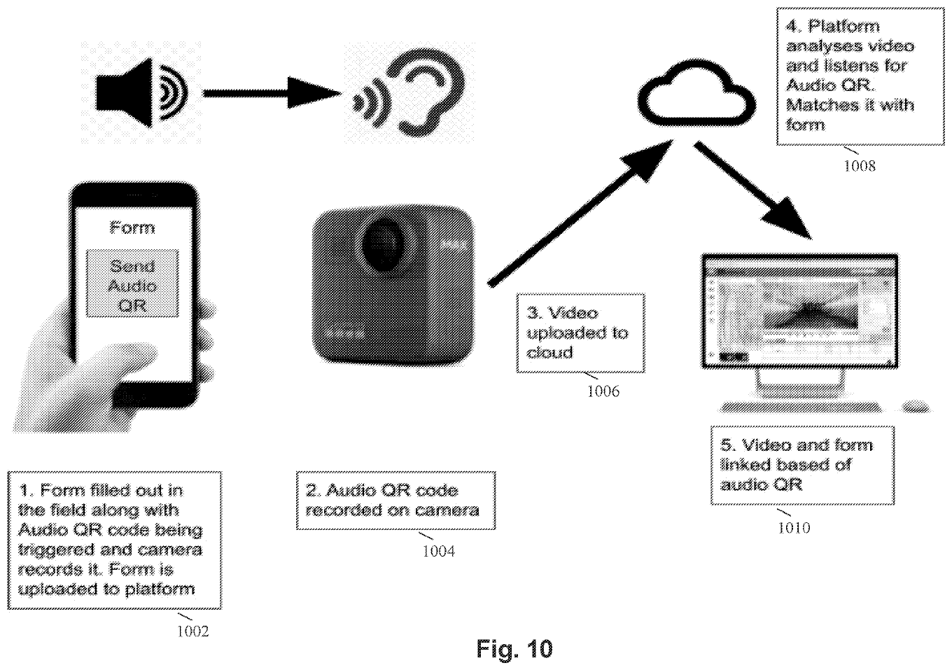

FIG. 10 depicts pairing of a camera 102 and a form created on a secondary device like a smartphone or tablet, according to an embodiment of the present disclosure. In one embodiment, the secondary device can take videos and images and can also sync with the videos and images to create a multi-view inspection.

Referring to FIG. 10, the process of using a QR code and or sound signature code described and herein allows a user to capture video and tag/attach a form to that video that was filled out in the field from a secondary device at step 1002. The form is implemented into a smart device app. The form captures details about the asset and a piece of infrastructure that is to be inspected or recorded. This can include asset ID, reference number, unique ID, date, operator, location, time, inspection type, inspection device used, purpose of inspection, or survey and any other supplementary information related to the asset.

At step 1004, the operator activates a mobile device (e.g. smartphone, iPad, etc.) that has the app that includes the form and the code generator.

At step 1006, the app is linked to the operators login credentials to the cloud platform via Wi-Fi or some other internet connection.

At step 1008, the operator fills out the form on the device and initiates the code generator to pair it with the camera using either or both a QR code and or sound signature in step 1008. The app on the device allows the operator to fill out the necessary information of the asset and the inspection. The necessary information can include asset ID, geolocation of the asset, time, date, weather, type of asset, asset depth, asset size, asset condition, operator, operators ID, purpose, type of inspection, or the like. The app generates a unique signature that is linked with the form that is being filled out in the form of either or both a QR code and sound signature code. The operator can either place the app with the QR code to face the video camera or have it close to the camera so it can record the sound signature code. The video camera is turned on and placed into recording and captures either or both the QR code and the sound signature code once initiated by the operator. The form is uploaded to the cloud platform and updates the database with the relevant fields and codes that were generated and waits for a video to be attached/paired. The video is then uploaded and analyzed using the cloud platform to identify either the QR code, sound signature or another identifier. The identifier can be either at the start or end of the video. The other identifier can include a tag or bookmark in the video at a very specific time, e.g., 1.283 s. The other identifier can also include a unique sound signature in the video.

At step 1010, using computer vision, machine learning, neural network or sound algorithms, the identifier recorded in the video is detected and paired/attached to the form. The attached form to the video auto populates the information in the platform removing the need to reenter the information.

FIG. 11, shows a flowchart depicting the steps taken to reach post processing of the video inspection and geolocating with real world coordinates. The operator can adjust the aesthetics of the video including, without limitation: color correction/white balance; exposure; brightness; contrast; and hue/saturation using the cloud platform. The operator can also correct white balance by finding the color card on the mapping device 100 in the video footage.

At step 1102, data is captured. The data can be video or photos but can also include other sensor data like the roll, tilt, pitch, the camera exchangeable image file format (EXIF) data, which are interior orientations. The LIDAR described earlier can actively capture 3D data.

At step 1104, the data captured is transferred by downloading or wireless transfer.

At step 1106, the data is transferred to a cloud. If the data is a video, then the data is tagged with forms if filled out.

At step 1108, the data is synchronized. Information is extracted from the form and paired with the data.

At step 1110, the data is assigned to a physical asset or an infrastructure in the real world.

At step 1112, perform a post processing procedure for the data if needed. The post processing procedure includes changing the brightness, exposure, sharpness, international organization for standardization (ISO), hue, saturation, or the like, by post processing tools.

At step 1114, perform a data processing stabilization by removing unwanted spin, bounce, wobble, or the like, if needed.

At step 1116, perform the data processing by visual simultaneous localization and mapping (VSLAM).

At step 1118, create an arbitrary sparse point cloud.

At step 1120, perform a data transformation or correction to known dimensions or references. In this step, an arbitrary point cloud can be used to match the identified landmarks in it to the real world known locations of those landmarks to identify the georeferenced locations. In some embodiments, matching the data to coordinate system that the user uses in either a x,y,z, or latitude and longitude and elevation, world geodetic system 1984 (WGS84), or coordinate reference system (CRS).

At step 1122, tag the data to real world coordinates.

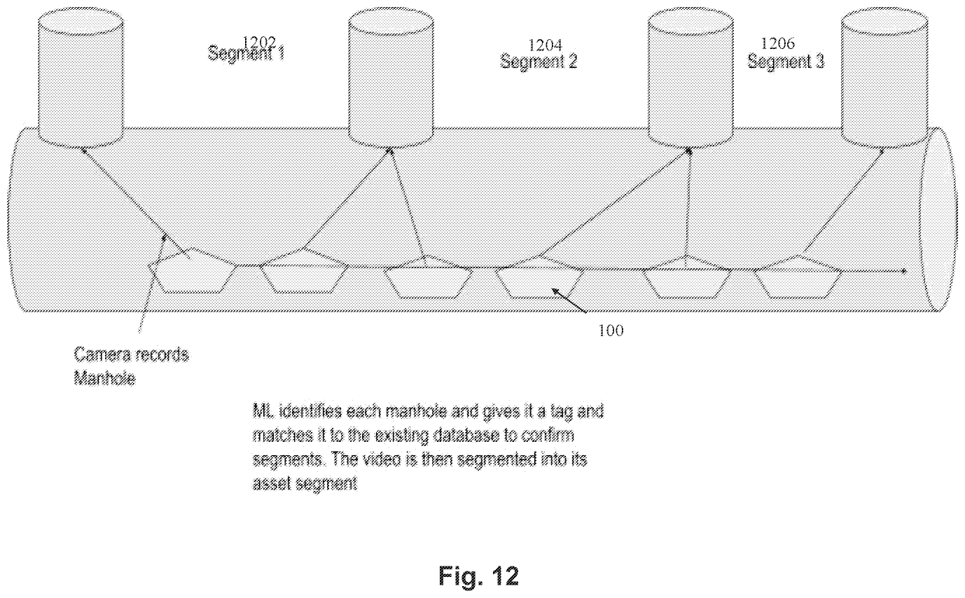

FIG. 12 depicts the segmentation of an inspection based on reference points from within a confined space, according to an embodiment of the present disclosure. For example, manholes are used as a known reference point and segmentation point, machine learning is then used to identify and segment the videos.

In one embodiment, video splitting is based on machine learning identification of manholes from a continuous deployment and recording. The mapping device 100 may have recorded information across multiple inspection segments 1202, 1204, 1206, e.g. multiple pipe segments, during one deployment as shown in FIG. 12. The video may be split to form specific videos for each inspection segment. For example, the stabilized smaller video is then analyzed to detect manholes using a machine learning algorithm. The machine learning algorithm detects likely manholes, tags the location, and combines the tags in a tagged list. The tagged list can be based off geographical information system (GIS), e.g., mh1, mh2, mh3, mh4, or the like. The user then checks the supplied manhole list with the tagged list to see if it is correct. If it is correct, the user gives each correct tag on the tagged list the respective name from the supplied manhole list. If the tag does not correctly identify a manhole, then the user notes that, e.g., in the name of the tag. The single video can be split into multiple videos, one for each manhole, and/or pipe segment, and labeled with the respective location information, e.g., pipe number, manhole ID, asset ID, or other naming conventions, etc. These individual videos, that were extracted from the original video, can be used to inspect a single location at a time.

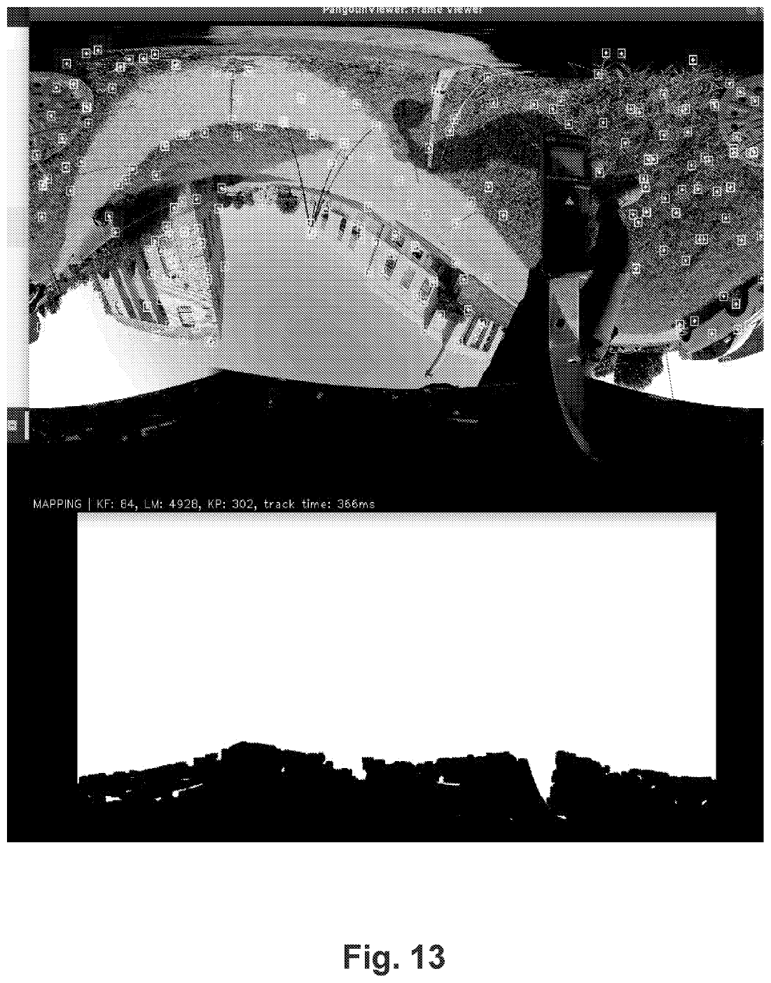

FIG. 13 is a screenshot of a mask being applied to an image, according to an embodiment of the present disclosure. The screenshot of data from a mapping device 100 can be analyzed. The mask is derived using computer vision algorithms to mask out parts of the image that remain static. For example parts of the mapping device that can be seen in the video. A mask can be created over static objects such as the mapping device 100 in the video. The masked out area does not get processed as it results in errors in the mapping and localization of the camera and the environment.

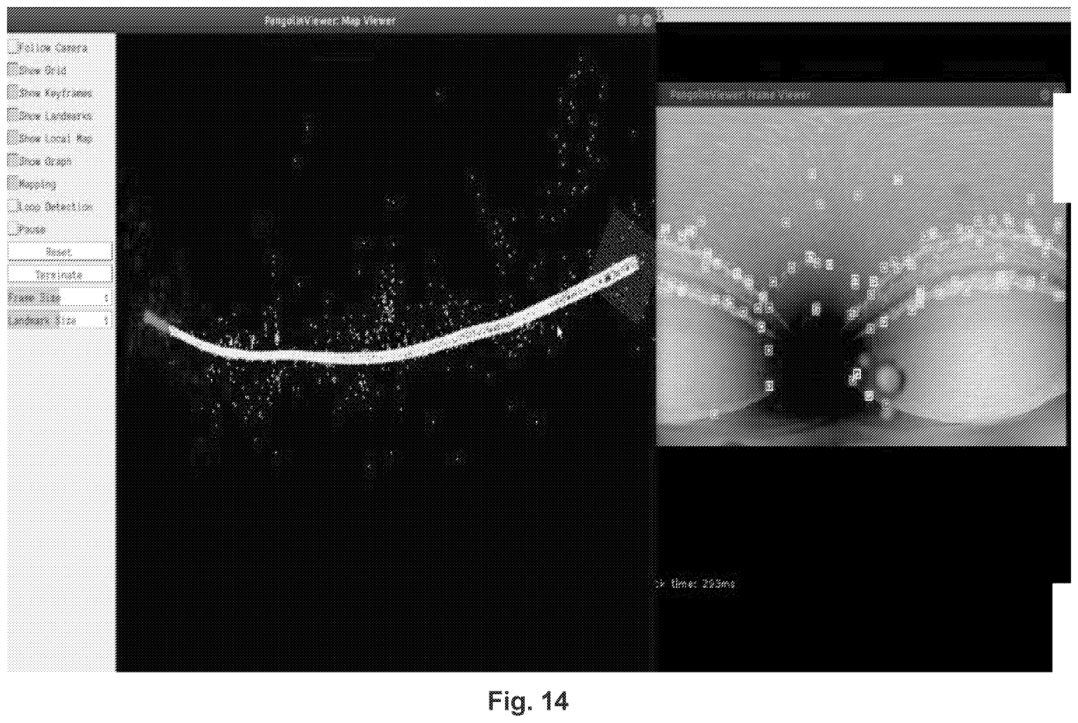

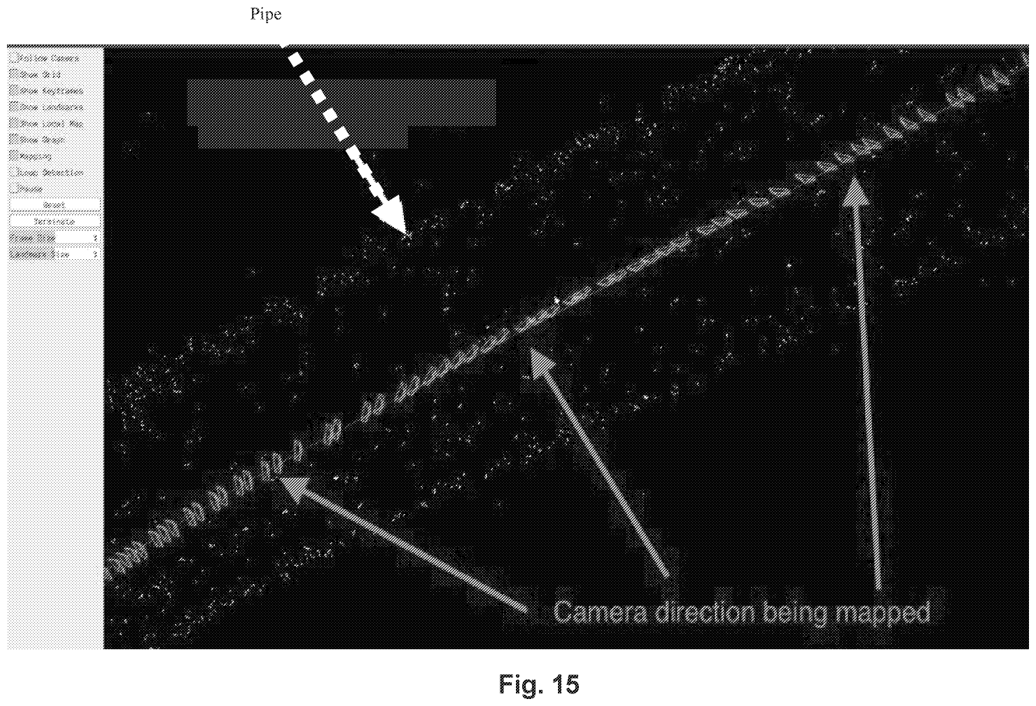

FIG. 14 is a screenshot of data from a mapping device being analyzed, according to an embodiment of the present disclosure. The screenshot shows the raw data and the features being tracked. A point cloud viewer showing the camera being localized and the environment being mapped is shown on the left of FIG. 14. FIG. 15 is a screenshot of data from a mapping device 100 being analyzed, according to an embodiment of the present disclosure. The screenshot in FIG. 15 is another image representing the VSLAM process with reference points being the camera module 102 and representing its position and the dots being the environment or the pipes.

Referring to FIGS. 14 and 15, examples of the visual simultaneous localization and mapping (VSLAM) process using the visual data from a camera module 102 and data from other optional sensors are shown. The VSLAM process involves computer vision algorithms to detect and track features in consecutive frames. The camera pose is calculated based on the tracking of environmental features while simultaneously the environment/surroundings. e.g., a pipe, tunnel, chamber, etc., are mapped. The mapping can be reconstructed in 3D as a sparse point cloud. Using known measurements or reference landmarks from within the video the arbitrary point cloud can be transformed to fit into a real world location. Using data provided by a user relating to an asset (e.g., manhole shaft, lateral pipe connection, junction, chamber, etc.), a synthetic version of the asset with known dimensions can be built. In some embodiments, a reconstructed arbitrary point cloud can be fitted within a synthetic pipe, e.g., 36″ circular pipe. Once corrected, the trajectory results from the camera pose calculation, and can act as a georeferenced path resulting in the location, direction, and velocity of the camera and associated features. By working out the bearing of the camera at every frame, the video can be stabilized to point in the direction of the trajectory. The process corrects for the significant spinning and pitching of the mapping device 100. The camera direction being mapped is shown in the solid arrow in FIG. 15 and the dots in FIG. 15 shows locations of pipes.

In one embodiment, spatial correction is performed. The arbitrary X, Y, Z trajectory is corrected with the real reference point X, Y, Z location. For example the point in the middle of the manhole can be used as the reference point. When the manhole is directly in the middle of the video, this arbitrary X, Y, Z location is given the real X, Y, Z value. This can be done for both start and end manhole. The arbitrary X, Y, Z values can then be corrected/transformed to the real coordinates. The user can further define the values by identifying other landmark X, Y, Z locations supplied. For example, if the location of inlets or features are supplied and then found in the video, the arbitrary X, Y, Z trajectory can be further refined. On repeat inspections, the optical flow and visual simultaneous localization and mapping (VSLAM) calculations can also be refined to fit the real-world coordinates.

In one embodiment, video geotag is performed. Each frame of the video can be assigned an X, Y. Z, either arbitrary or real, and put in a geospatial file. The geospatial file can be supplied to or viewed by a client for reviewing, for example, a distance along a pipe or a depth of a manhole or chamber.

In some embodiments, optional initial video stabilization such as camera pose can be performed. The video can optionally be segmented into a smaller video file by lowering the resolution, converting to grayscale, or reducing the frame rate. A new video for analysis can be created or the algorithm can reference parts of the video to use without having to replicate the initial file. The video is analyzed using an algorithm to understand the pose of the mapping device 100 as shown later in FIG. 14. The direction of the camera module 102 and a general direction of movement can be calculated. The optical flow results are then used to stabilize the original video to produce a forward facing smooth video free from spin, roll, and wobble.

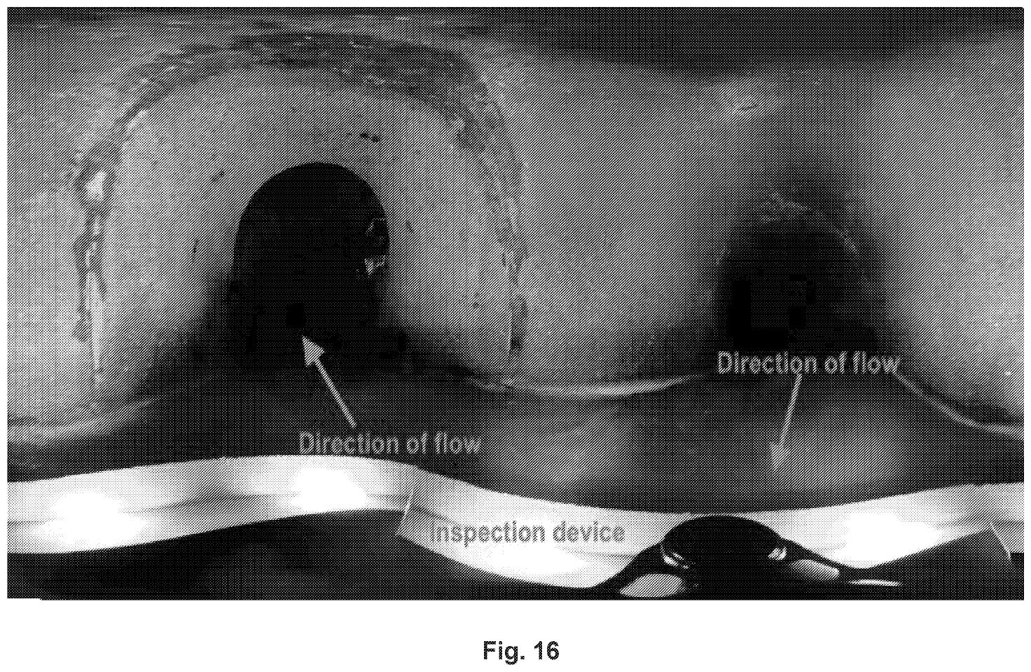

FIG. 16 is an equirectangular image taken from the mapping device 100 within a pipe. The equirectangular panoramic image of the sewer environment is taken from the mapping device 100. The equirectangular image depicts the mapping device 100 in a pipe and a direction that the mapping device 100 is traveling. FIG. 16 shows distortions at the poles of an image. FIG. 16 also shows an equirectangular image and results in the image being distorted around the poles (e.g., top and bottom) of the image similar to trying to flatten a spherical map of the world.

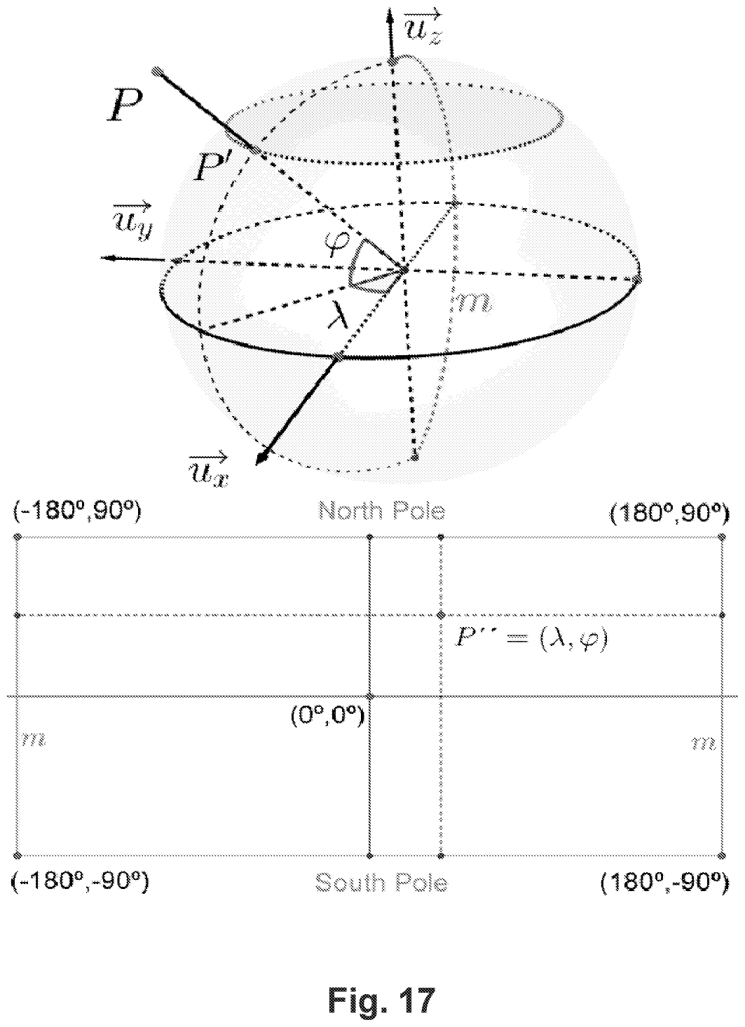

FIG. 17 illustrates how a spherical (360°) image is transformed to an equirectangular image. The image can be a transformation from an equirectangular panoramic image to a sphere and vice-versa, according to an embodiment of the present disclosure.

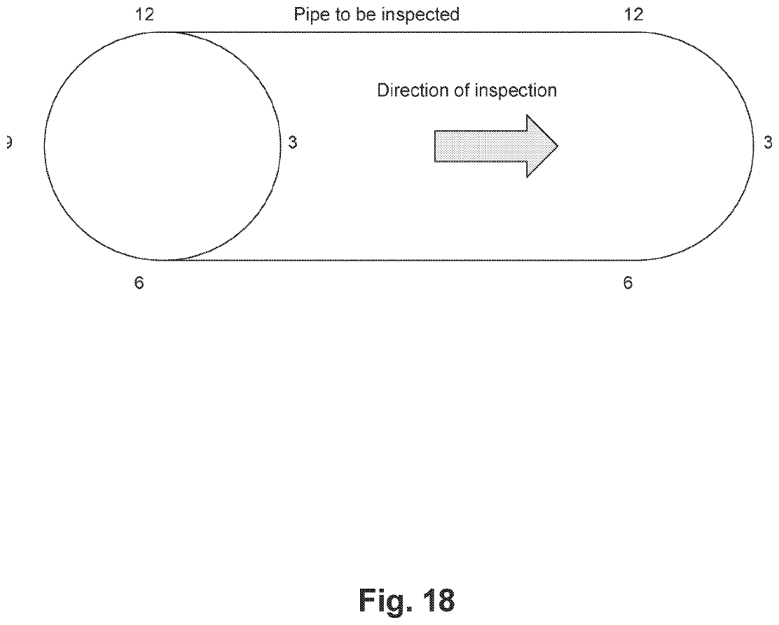

FIG. 18 illustrates an inspection of a pipe and the orientation of a clock reference, according to an embodiment of the present disclosure. In FIG. 18, a pipe is shown, and the associated clock references in relation to the direction of the inspection is also shown. The direction can be such as moving along one direction (e.g., a forward direction). In FIG. 18, 12 o'clock represents a direction to the top, 3 o'clock represents a direction to the right, 6 o'clock represents a direction to the bottom, and 9 o'clock represents a direction to the left.

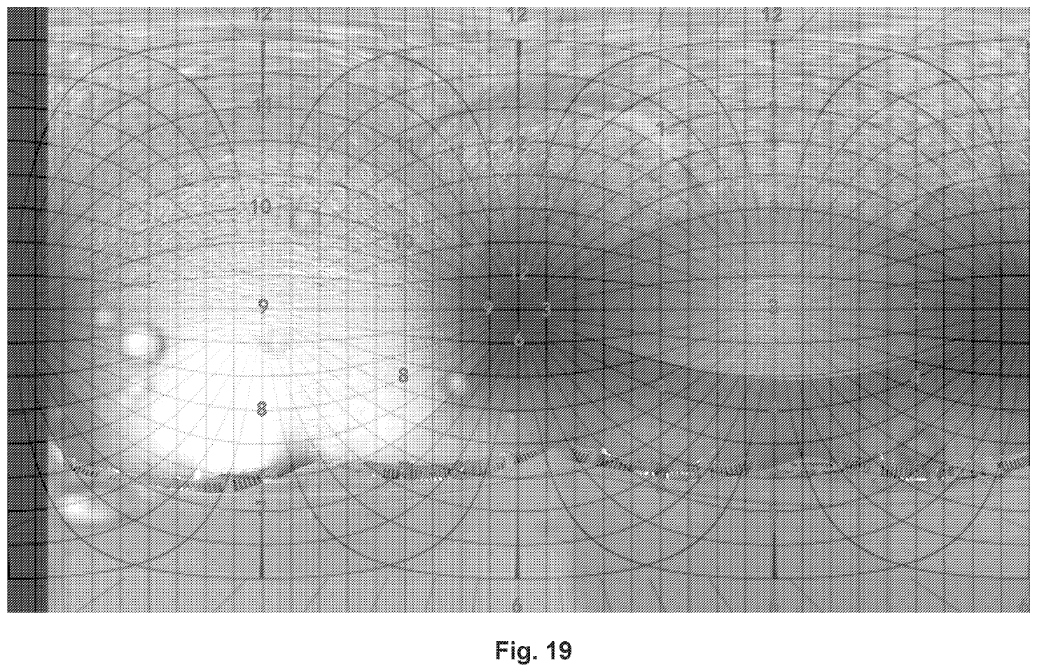

Referring to FIG. 17 and later in FIG. 19, how a spherical (360°, globe) clock reference is to be used in conjunction with 3600 video or imagery is shown. The clock reference in a 360° space is used for specifying the location of a feature or defect within a pipe inspection in a confined space.

FIG. 17 shows converting a spherical coordinate (e.g., yaw or pitch) or (e.g., horizontal angle or vertical angle) from a 360° video or image into a (x, y) cartesian position that we can then relate to a 12 hour clock reference. The center of the image sphere is (0,0) and relates to (x=0, y=0) that relates to the center of the clock. Anything to the left of (0, 0) relates to the left hand side of the clock and anything to the right is the right hand side of the clock. (0, 0) is the center in the image and the direction of an inspection. If the user plans to look backwards using the sphere, the clock reference (0,0) can be reversed. In some embodiments, the circular clock perpendicular to pipe direction provides an ability to match the spherical (0,0,0) to the cartesian (x,y) center.

FIG. 19 is a screenshot depicting a 3600 clock overlaid on top of a 360° image, according to an embodiment of the present disclosure. The screenshot shows equirectangular images or videos but can include cube maps and other 3600 formats. FIG. 19 is a screenshot depicting a spherical clock overlaid on top of a flattened 360° image such as equirectangular image/video shown but can include cube maps and other 3600 formats. The latitude and longitude of the sphere correlate with 2D clock references. For example, the equator latitudes equal to 9 am and 3 pm, respectively, while the north and south poles refer to 12 o'clock and 6 o'clock. The latitude lines can assist in the clock reference even when an operator looks backwards but still retains the appropriate clock reference in relation to the inspection survey direction.

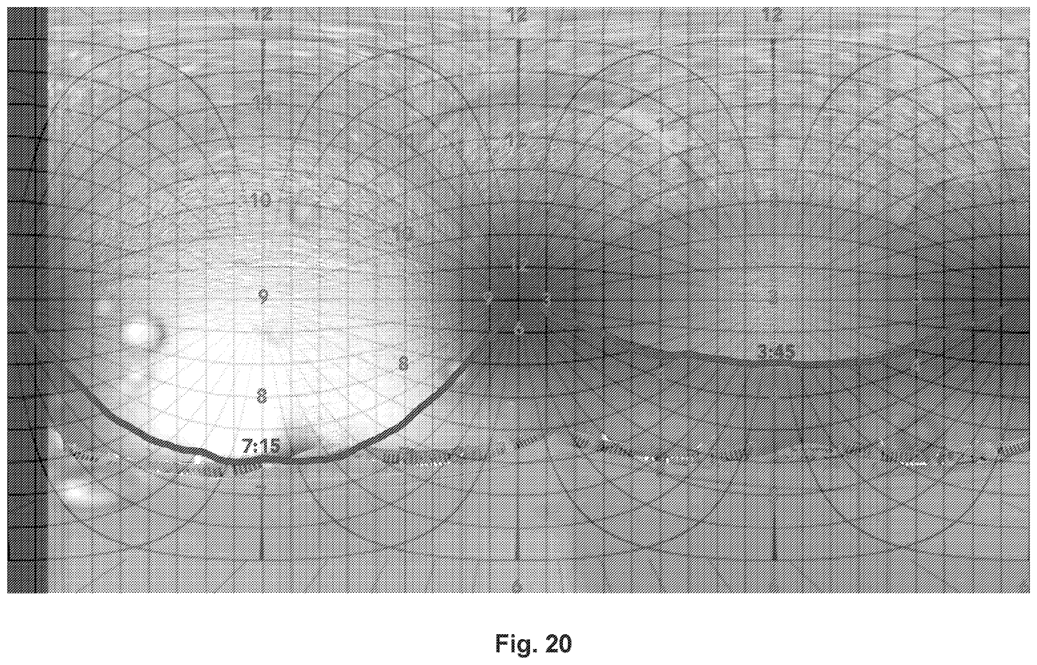

FIG. 20 is a screenshot showing the detection of the water level observation within a pipe from a 360° image with a 360° clock to extract measurement, according to an embodiment of the present disclosure. The screenshot in FIG. 20 shows the water level observation within a pipe from a 360° image with a 360° clock reference. The position of the mapping device 100 does not impact the water height calculation. By detecting either side of the waterline from the image and using the clock references the water height can be ascertained at that location. The computer vision algorithm can detect and calculate this automatically as the video is played. For example, in FIG. 20, the left side waterline is equal to 7:15 am or 42 minutes approximately and the right side is equal to 3:45 pm or 20 minutes. As an example, the diameter of the pipe is equal to 2 m. Therefore we know that 12 hours equals 2 m diameter and 1 hour would equal 0.17 m circumference. The difference between 3:45 and 7:15 equates to 3.5 hours which in turn equals 0.59 m circumference that is filled with water. The volume can then be calculated.

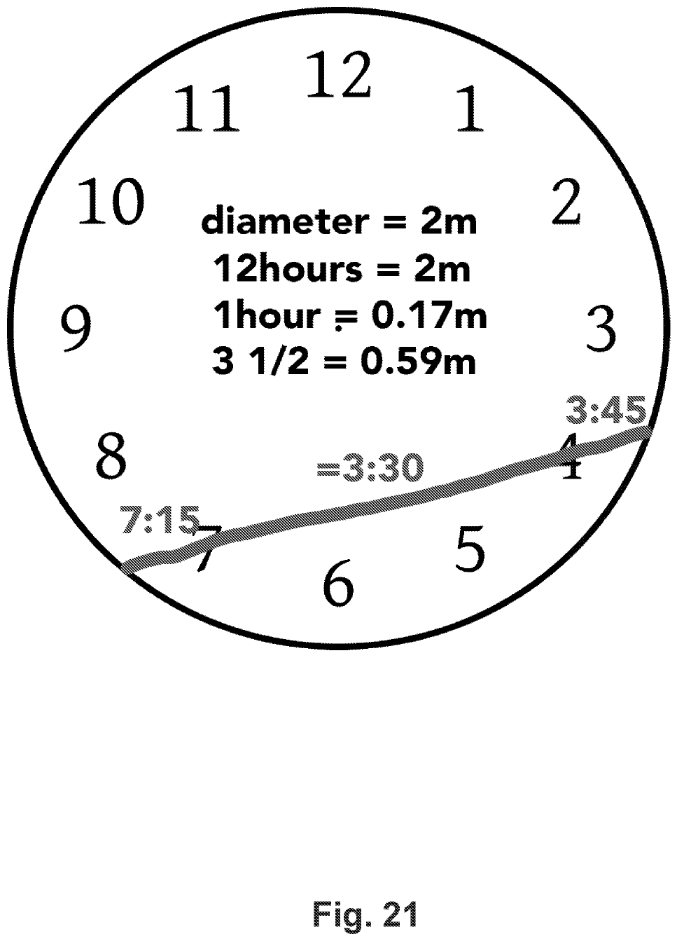

FIG. 21 depicts the calculation in determining the height of water within a pipe using the segment algorithm of a circle, according to an embodiment of the present disclosure.

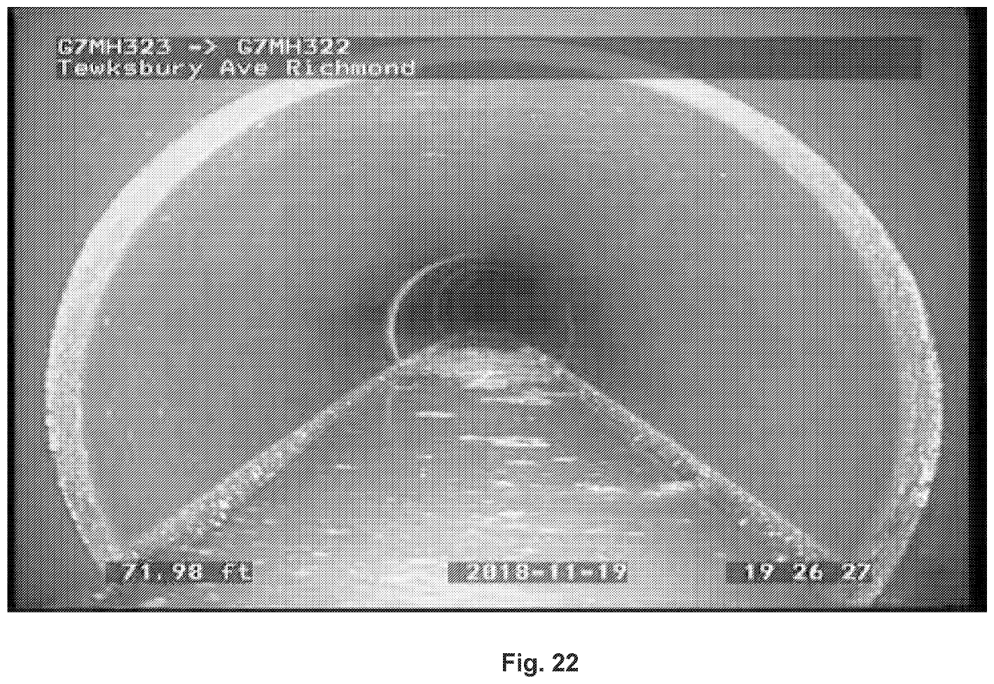

FIG. 22 is an image of a typical CCTV sewer inspection looking straight down the pipe in the direction of the inspection, according to an embodiment of the present disclosure. The image shows that the calculation of a segment is within a circle.

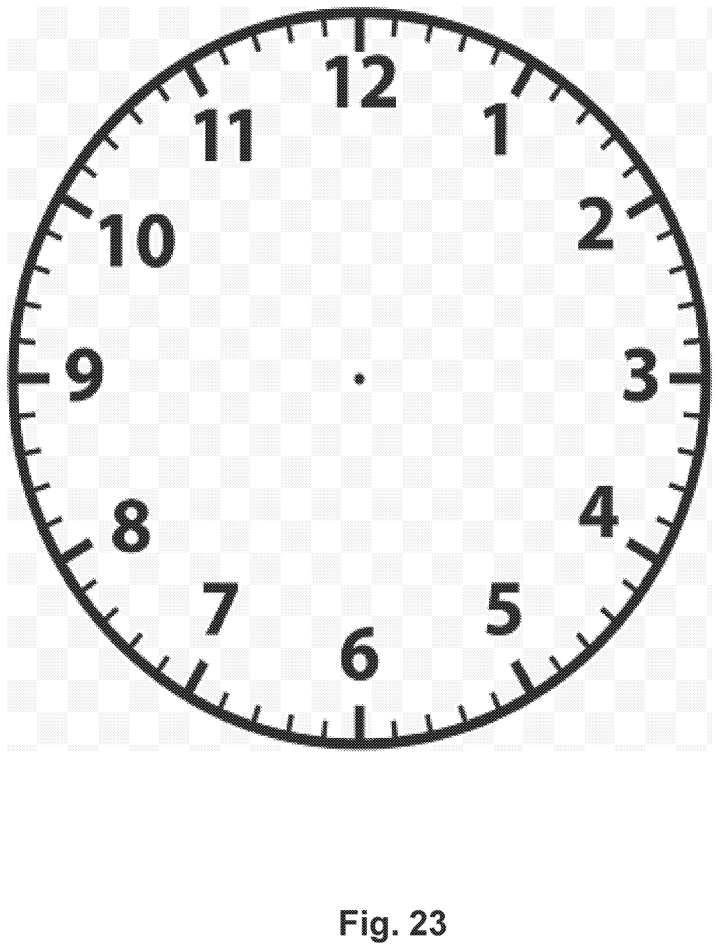

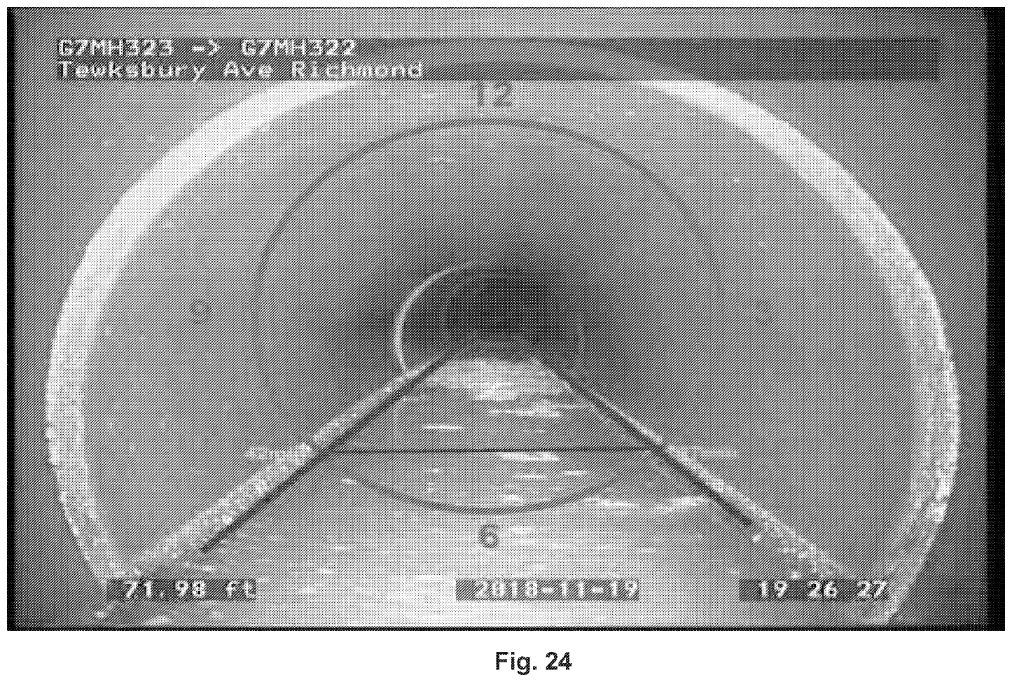

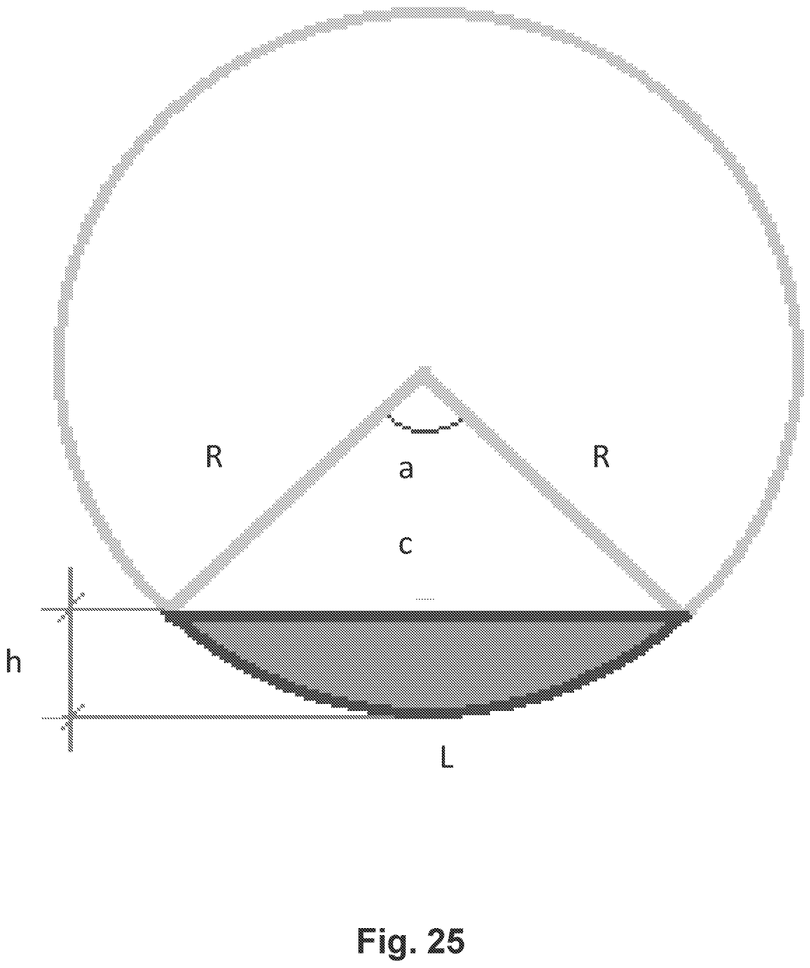

FIG. 23 is a clock overlay that is used for CCTV sewer inspection videos, according to an embodiment of the present disclosure. FIG. 24 depicts an automatic detection of the waterline from CCTV sewer inspection and a calculation of the water height using the algorithm to measure a segment of a circle, according to an embodiment of the present disclosure. FIG. 25 illustrates the calculation of a segment of a circle, according to an embodiment of the present disclosure.

Referring to FIG. 22, FIG. 23, FIG. 24 and FIG. 25, these figures show that the same automatic water height within a pipe can be calculated but from a single or monocular front facing CCTV video or image. Using the similar computer vision algorithm the height can be calculated in real time to give an estimated water height calculation. If we assume that the circular pipe relates to a round 12 hour clock, the water height can then be calculated in the pipe and relate it to the clock reference. A percentage of the pipe filled at that location can also be calculated based on this calculation.

In one embodiment, from the mapping device 100 described earlier in FIGS. 1-3 or other floating mapping device, an operator can determine the underlying surface characteristic based on the water roughness characteristics.

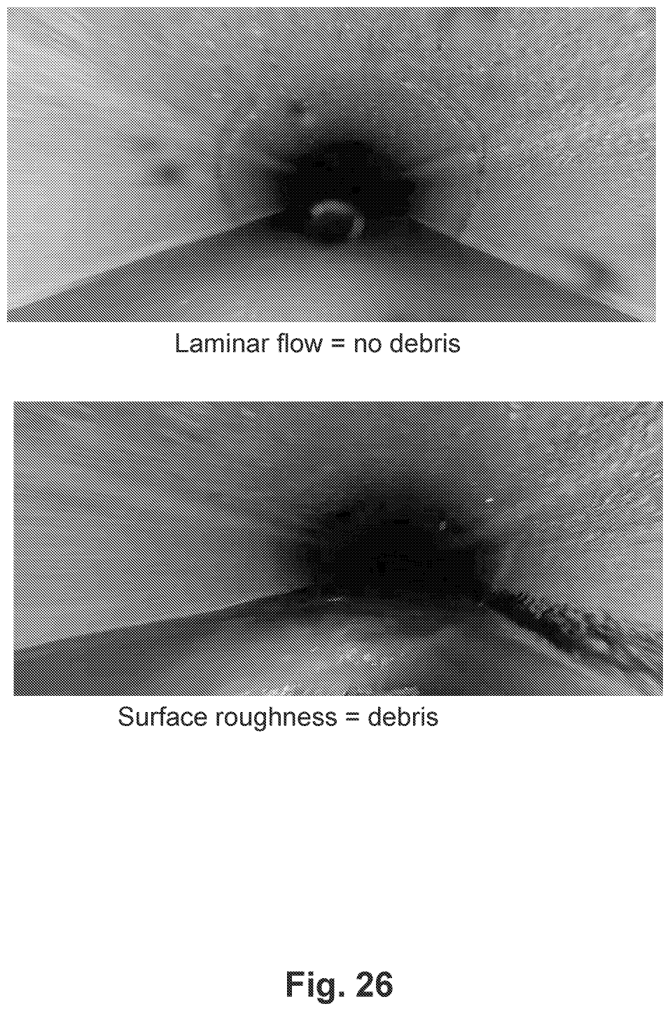

FIG. 26 is a series of images of a RAW sewer video depicting water surface characterization for calculating the underlying base surface, according to an embodiment of the present disclosure. The two images in FIG. 26 show laminar flow of a clear pipe in the image on the top and the increased surface roughness as a result of underlying debris within the pipe in the image on the bottom.

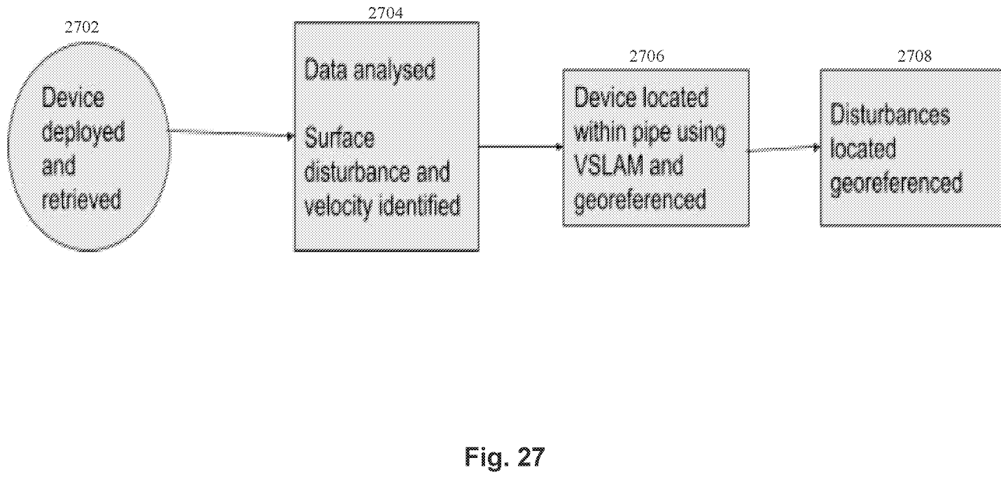

FIG. 27 is a flowchart of water surface analysis, according to an embodiment of the present disclosure. The flowchart describes how other characteristics from the free floating mapping device 100 can determine the underlying surface. By calculating the attributes of the mapping device 100, that can include velocity and bobbing, can also infer a surface water characteristic.

At step 2702, an mapping device 100 is deployed and retrieved.

At step 2704, data is analyzed. Surface disturbance and velocity are identified.

At step 2706, the mapping device 100 is located within a pipe using VSLAM and georeferenced.

At step 2708, one or more disturbances are located georeferenced.

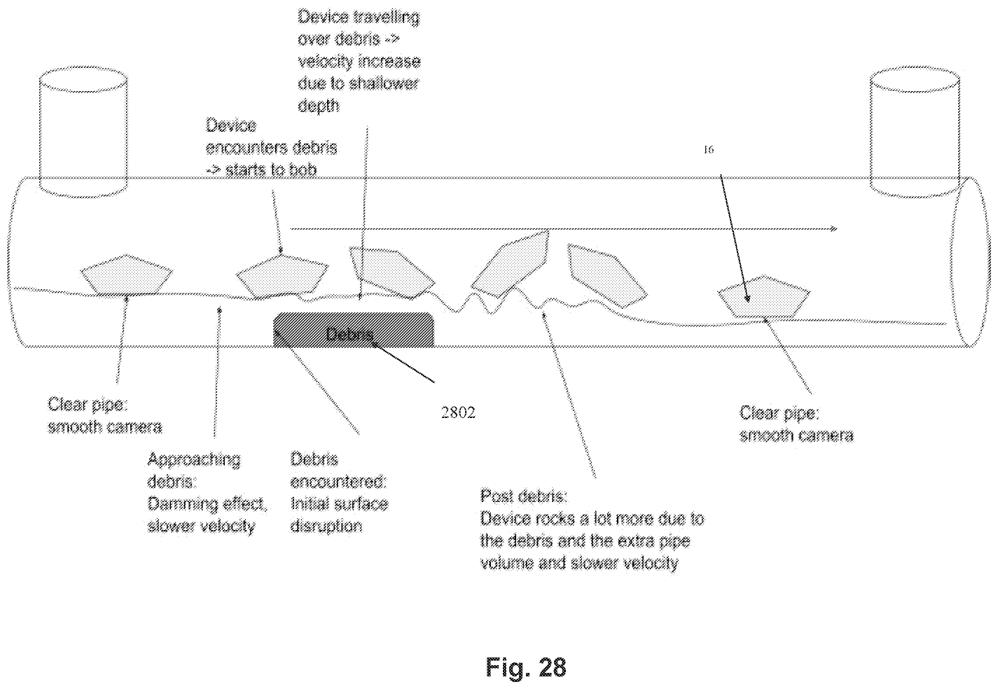

FIG. 28 illustrates how underlying surface impacts water surface characteristic, according to an embodiment of the present disclosure. The illustration also shows how the debris 2802 impacts the water depth, velocity, surface characteristics and the device behavior. By using standard fluvial geomorphology, wave characteristics, hydraulic characteristics and the movement of the mapping device 100, the different conditions that are occurring under the water can be identified. For example, higher velocity means shallower depth of water while slower velocity means a deeper water, and the deeper water means a damming effect including damming by debris. Another example can include, bobbing or rolling of the device can be analyzed to determine water roughness.

In general, it will be apparent to one of ordinary skill in the art that at least some of the embodiments described herein can be implemented using many different embodiments of software, firmware, and/or hardware. The software and firmware code can be executed by a processor or any other similar computing device. The software code or specialized control hardware that can be used to implement embodiments is not limiting. For example, embodiments described herein can be implemented in computer software using any suitable computer software language type, using, for example, conventional or object-oriented techniques. Such software can be stored on any type of suitable computer-readable medium or media, such as, for example, a magnetic or optical storage medium. The operation and behavior of the embodiments can be described without specific reference to specific software code or specialized hardware components. The absence of such specific references is feasible, because it is clearly understood that artisans of ordinary skill would be able to design software and control hardware to implement the embodiments based on the present description with no more than reasonable effort and without undue experimentation.

Moreover, the processes described herein can be executed by programmable equipment, such as computers or computer systems and/or processors. Software that can cause programmable equipment to execute processes can be stored in any storage device, such as, for example, a computer system (nonvolatile) memory, an optical disk, magnetic tape, or magnetic disk. Furthermore, at least some of the processes can be programmed when the computer system is manufactured or stored on various types of computer-readable media.

It can also be appreciated that certain portions of the processes described herein can be performed using instructions stored on a computer-readable medium or media that direct a computer system to perform the process steps. A computer-readable medium can include, for example, memory devices such as diskettes, compact discs (CDs), digital versatile discs (DVDs), optical disk drives, or hard disk drives. A computer-readable medium can also include memory storage that is physical, virtual, permanent, temporary, semi-permanent, and/or semi temporary.

A “computer,” “computer system,” “host,” “server,” or “processor” can be, for example and without limitation, a processor, microcomputer, minicomputer, server, mainframe, laptop, personal data assistant (PDA), wireless email device, cellular phone, pager, processor, fax machine, scanner, or any other programmable device configured to transmit and/or receive data over a network. Computer systems and computer-based devices disclosed herein can include memory for storing certain software modules used in obtaining, processing, and communicating information. It can be appreciated that such memory can be internal or external with respect to operation of the disclosed embodiments. The memory can also include any means for storing software, including a hard disk, an optical disk, floppy disk, ROM (read only memory), RAM (random access memory), PROM (programmable ROM), EEPROM (electrically erasable PROM) and/or other computer-readable media. Non-transitory computer-readable media, as used herein, comprises all computer-readable media except for a transitory, propagating signals.

In various embodiments disclosed herein, a single component can be replaced by multiple components and multiple components can be replaced by a single component to perform a given function or functions. Except where such substitution would not be operative, such substitution is within the intended scope of the embodiments.

Some of the figures can include a flow diagram. Although such figures can include a particular logic flow, it can be appreciated that the logic flow merely provides an exemplary implementation of the general functionality. Further, the logic flow does not necessarily have to be executed in the order presented unless otherwise indicated. In addition, the logic flow can be implemented by a hardware element, a software element executed by a computer, a firmware element embedded in hardware, or any combination thereof.

Particular embodiments of the subject matter have been described. Other embodiments are within the scope of the present disclosure. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

It is to be understood that the above descriptions and illustrations are intended to be illustrative and not restrictive. It is to be understood that changes and variations may be made without departing from the spirit or scope of the following claims. Other embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventor did not consider such subject matter to be part of the disclosed inventive subject matter.

Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having thus described several aspects of at least one embodiment of this invention, it is to be appreciated that various alterations, modifications, and improvements will readily occur to those skilled in the art. Such alterations, modifications, and improvements are intended to be part of this disclosure and are intended to be within the spirit and scope of the invention. Accordingly, the foregoing description and drawings are by way of example only.

The foregoing description of embodiments and examples has been presented for purposes of illustration and description. It is not intended to be exhaustive or limiting to the forms described. Numerous modifications are possible in light of the above teachings. Some of those modifications have been discussed, and others will be understood by those skilled in the art. The embodiments were chosen and described in order to best illustrate principles of various embodiments as are suited to particular uses contemplated. The scope is, of course, not limited to the examples set forth herein, but can be employed in any number of applications and equivalent devices by those of ordinary skill in the art. Rather it is hereby intended the scope of the invention to be defined by the claims appended hereto.

Obviously, numerous modifications and variations are possible in light of the above teachings. It is therefore to be understood that within the scope of the appended claims, embodiments of the present disclosure may be practiced otherwise than as specifically described herein.

1. A system for mapping a confined space, the system comprising:
a mapping device comprising a camera configured to capture image data depicting a transit of the confined space by the mapping device; and
an image processing system comprising a processor and a memory, wherein the processor is configured to execute instructions stored on the memory to perform the operations of:
processing the image data to determine a first set of locations of the mapping device as it transits the confined space; and
processing the image data to determine a second set of locations of one or more features or one or more defects associated with the confined space.

2. The system of claim 1, wherein the camera is disposed on a camera module removably attached to the mapping device.

3. The system of claim 1, further comprising a light module removably attached to the mapping device, the light module comprising an array of lights disposed about the mapping device.

4. The system of claim 1, further comprising a float attachment structure, wherein the mapping device is removably disposed on or in the float attachment structure.

5. The system of claim 4, wherein the float attachment structure defines a channel extending at least in part through the float attachment structure.

6. The system of claim 4, wherein the float attachment structure comprises at least one fin and/or at least one hull.

7. The system of claim 6, wherein the at least one fin comprises an attachment hole configured to connectably receive a tether or a drag chain.

8. The system of claim 6, wherein the at least one hull comprises a bore extending through the at least one hull, wherein the bore is configured to cool and stabilize the mapping device.

9. The system of claim 1, further comprising a roll bar attached to the mapping device.

10. The system of claim 1, wherein the mapping device comprises one or more sensors, the one or more sensors comprising a luminance sensor, a barometer, a gas sensor, a humidity sensor, a temperature sensor, a tactile sensor, a proximity sensor, a sonar sensor, or a LIDAR sensor.

11. The system of claim 1, wherein at least a portion of the system is modular and physically configurable based on one or more environments in which the portion of the system is disposed, the one or more environments comprising a vertical confined space, a pipe, a subterranean environment, a vehicle, or a storage container.

12. The system of claim 1, wherein the processing the image data to determine the first set of locations of the mapping device comprises:
providing the image data as input to a visual simultaneous localization and mapping algorithm; and
mapping an environment within the confined space as a sparse point cloud.

13. The system of claim 12, wherein the operations further comprise transforming the sparse point cloud to fit into a real-world location.

14. The system of claim 1, wherein the operations further comprise mapping the first set of locations of the mapping device and the second set of locations of the one or more features or one or more defects to respective geographic coordinates.

15. The system of claim 14, wherein the one or more features comprises a manhole, a start of a pipe, a sewer segment, or a lateral connection.

16. The system of claim 14, wherein the one or more defects comprises a rock, debris, or a surface defect of the confined space.

17. The system of claim 1, wherein the operations further comprise stabilizing the image data.

18. The system of claim 1, wherein the operations further comprise tagging the image data with one or more identifiers, the identifiers comprising a sound signature or a scannable code.

19. The system of claim 1, wherein the image processing system is located in a server different than the mapping device.

20. A method for mapping a confined space, the method comprising:
receiving image data of a transit of the confined space by an inspection system comprising a mapping device;
processing the image data to determine a first set of locations of the mapping device as it transits the confined space; and
processing the image data to determine a second set of locations of one or more features or one or more defects associated with the confined space.

21.-37. (canceled)
